(19) United States
(12) Patent Application Publication
(10) Pub. No.: US 2024/0244703 A1
(43) Pub. Date: Jul. 18, 2024

(54) USER EQUIPMENT AND METHOD FOR HANDLING SMALL DATA TRANSMISSION

(71) Applicant: FG Innovation Company Limited, Tuen Mun (HK)

(72) Inventors: YUNG-LAN TSENG, Taipei (TW); HSIN-HSI TSAI, Taipei (TW); HENG-LI CHIN, Taipei (TW); MEI-JU SHIH, Taipei (TW)

(21) Appl. No.: 18/560,180

(22) PCT Filed: May 10, 2022
(86) PCT No.: PCT/CN2022/092016

§ 371 Date: Nov. 10, 2023

Related U.S. Application Data
(60) Provisional application No. 63/186,759, filed on May 10, 2021.

(51) Int. Cl. H04W 76/20; H04B 17/318; H04W 72/02; H04W 72/232

(52) U.S. Cl. CPC H04W 76/20; H04B 17/328; H04W 72/02; H04W 72/232

(57) ABSTRACT

A UE and a method for handling SDT are provided. The method includes receiving, from a serving cell, an SDT configuration associated with both an SUL carrier and an NUL carrier; selecting one of the SUL carrier and the NUL carrier as a first operating UL carrier when the UE is triggered to start an SDT procedure and while the UE is in an RRC inactive state; selecting at least one CG resource or at least one RA resource associated with the first operating UL carrier for the SDT procedure as at least one operating UL resource; performing the SDT procedure with the serving cell on the first operating UL carrier by using the at least one UL operating resource associated with the first operating UL carrier; disabling a switching from the first operating UL carrier to the other one of the SUL carrier and the NUL carrier during the SDT procedure.

### CROSS-REFERENCE TO RELATED APPLICATION(S)

The present disclosure is a National Stage Application of International Patent Application Serial No. PCT/CN2022/092016, filed on May 10, 2022, which claims the benefit of and priority to U.S. Provisional Patent Application Ser. No. 63/186,759, filed on May 10, 2021, the contents of all which are hereby incorporated herein fully by reference into the present disclosure for all purposes.

### FIELD

The present disclosure is related to wireless communication, and more specifically, to a user equipment (UE) and a method for handling smaill data transmission (SDT) in a next-generation wireless communication network.

### BACKGROUND

With the tremendous growth in the number of connected devices and the rapid increase in user/network traffic volume, various efforts have been made to improve different aspects of wireless communication for the next-generation wireless communicationsystems, such as the fifth-generation (5G) New Radio (NR) system, by improving data rate, latency, reliability, and mobility.

The 5G NR system is designed to provide flexibility and configurability for optimizing the network services and types and accommodating various use cases, such as enhanced Mobile Broadband (eMBB), massive Machine-Type Communication (mMTC), and Ultra-Reliable and Low-Latency Communication (URLLC).

However, as the demand for radio access continues to grow, there is a need for further improvements in wireless communications in the next-generation wireless communication system.

### SUMMARY

The present disclosure is related to a method for handling SDT performed by a UE.

According to a first aspect of the present disclosure, a method for handling SDT performed by a UE is provided. The method includes receiving, from a serving cell, an SDT configuration associated with both a supplementary uplink (SUL) carrier and a normal uplink (NUL) carrier; selecting one of the SUL carrier and the NUL carrier as a first operating uplink (UL) carrier when the UE is triggered to start an SDT procedure and while the UE is in a radio resource control (RRC) inactive state; selecting at least one configured grant (CG) resource or at least one random access (RA) resource associated with the first operating UL carrier for the SDT procedure as at least one operating UL resource; performing the SDT procedure with the serving cell on the first operating UL carrier by using the at least one UL operating resource associated with the first operating UL carrier; and disabling a switching from the first operating UL carrier to the other one of the SUL carrier and the NUL carrier during the SDT procedure.

According to an implementation of the first aspect, the first operating UL carrier is selected based on a downlink (DL) reference signal (RS) measurement result of the UE and a threshold configured by the SDT configuration for UL carrier selection during the SDT procedure, the DL RS measurement result is based on a reference signal received power (RSRP) associated with the serving cell, and the threshold is configured with a DL-RSRP value different from another DL-RSRP threshold value configured to the UE for UL carrier selection during an RRC resume procedure or an RRC setup procedure with the same serving cell.

According to another implementation of the first aspect, selecting the first operating UL carrier comprises: selecting the SUL carrier as the first operating UL carrier in a case that the DL RS measurement result is less than the threshold, and selecting the NUL carrier as the first operating UL carrier in a case that the DL RS measurement result greater than or equal to the threshold.

According to another implementation of the first aspect, the method further includes receiving, from the serving cell during the SDT procedure, first downlink control information (DCI) including a first indication, the first indication indicating an UL carrier switching from the first operating UL carrier to a second operating UL carrier, the second operating UL carrier being the other one of the SUL carrier and the NUL carrier; and performing the SDT procedure with the serving cell by transmitting at least one first transport block (TB) on a UL physical resource on the second operating UL carrier indicated by the first DCI.

According to another implementation of the first aspect, the method further includes switching from the second operating UL carrier back to the first operating UL carrier automatically after transmitting the at least one first TB on the UL physical resource indicated by the first DCI; and performing the SDT procedure with the serving cell on the first operating UL carrier.

According to another implementation of the first aspect, the method further includes receiving, from the serving cell during the SDT procedure, second DCI including a second indication after transmitting the at least one first TB on the UL physical resource indicated by the first DCI, the second indication indicating another UL carrier switching from the second operating UL carrier to the first operating UL carrier; and performing the SDT procedure with the serving cell by transmitting at least one second TB on a UL physical resource on the first operating UL carrier indicated by the second DCI.

According to another implementation of the first aspect, the at least one CG resource on the first operating UL carrier for the SDT procedure is selected as the at least one operating UL resource in a case that the at least one CG resource is available for the SDT procedure when a time alignment (TA) timer of the at least one CG resource is still running when selecting the at least one operating UL resource.

According to another implementation of the first aspect, the method further includes releasing all of configured CG resources on the NUL carrier and the SUL carrier in a case that a time alignment (TA) timer of the at least one CG resource expires.

According to another implementation of the first aspect, the at least one RA resource on the first operating UL carrier for the SDT procedure is selected as the at least one UL operating resource in a case that there is no available CG resource associated with the first operating UL carrier.

According to a second aspect of the present disclosure, a UE for handling SDT is provided. The UE includes one or more non-transitory computer-readable media storing one or more computer-executable instructions; and at least one processor coupled to the one or more non-transitory computer-readable media. The at least one processor is configured to execute the one or more computer-executable instructions to cause the UE to receive, from a serving cell, an SDT configuration associated with both an SUL carrier and an NUL carrier; select one of the SUL carrier and the NUL carrier as a first operating UL carrier when the UE is triggered to start an SDT procedure and while the UE is in an RRC inactive state; select at least one CG resource or at least one RA resource associated with the first operating UL carrier for the SDT procedure as at least one operating UL resource; perform the SDT procedure with the serving cell on the first operating UL carrier by using the at least one UL operating resource associated with the first operating UL carrier; and disable a switching from the first operating UL carrier to the other one of the SUL carrier and the NUL carrier during the SDT procedure.

### BRIEF DESCRIPTION OF THE DRAWINGS

Aspects of the present disclosure are best understood from the following detailed description when read with the accompanying drawings. Various features are not drawn to scale. Dimensions of various features may be arbitrarily increased or reduced for clarity of discussion.

FIG. 1A is a schematic diagram illustrating the coverage areas of an NUL carrier and an SUL carrier, according to an example implementation of the present disclosure.

FIG. 1B is a schematic diagram illustrating the frequency ranges of resources allocated to an SUL carrier and an NUL carrier, according to an example implementation of the present disclosure.

FIG. 2 is a schematic diagram illustrating the RRC state transition in NR, according to an example implementation of the present disclosure.

FIG. 3 is a signaling flow diagram illustrating initiation and completion of an SDT procedure, according to an example implementation of the present disclosure.

FIG. 4 is a flowchart illustrating a UL carrier selection approach based on a resume cause, according to an example implementation of the present disclosure.

FIG. 5 is a signaling flow diagram illustrating an initiation and fallback mechanism of an SDT procedure, according to an example implementation of the present disclosure.

FIG. 6 is a flowchart illustrating a method for handling SDT performed by a UE, according to an example implementation of the present disclosure.

FIG. 7 is a block diagram illustrating a node for wireless communication, according to an example implementation of the present disclosure.

### DESCRIPTION

Some of the acronyms in the present disclosure are defined as follows and unless otherwise specified, the acronyms have the following meanings:

| Abbreviation | Full name |
|---|---|
| 3GPP | 3^{rd} Generation Partnership Project |
| 5G | 5^{th} Generation |
| 5GC | 5G Core |
| ACK | Acknowledgment |
| AMF | Access and Mobility Function |
| ARQ | Automatic Repeat Request |
| AS | Access Stratum |
| BS | Base Station |
| BSC | Base Station Controller |
| BWP | Bandwidth Part |
| C-RNTI | Common-Radio Network Temporary Identifier |
| CA | Carrier Aggregation |
| CBRA | Contention-Based Random Access |
| CC | Component Carrier |
| CFRA | Contention-Free Random Access |
| CG | Configured Grant |
| CM | Connection Management |
| CN | Core Network |
| CP | Cyclic Prefix |
| CS-RNTI | Configured Scheduling-Radio Network Temporary |
| | Identifier |
| DO | Dual Connectivity |
| DCI | Downlink Control Information |
| DL | Downlink |
| DRB | Data Radio Bearer |
| DRX | Discontinuous Reception |
| E-UTRA(N) | Evolved Universal Terrestrial Radio Access (Network) |
| eMBB | enhanced Mobile Broadband |
| eNB | evolved Node B |
| EN-DC | E-UTRA NR Dual Connectivity |
| EPC | Evolved Packet Core |
| gNB | Next-Generation Node B |
| GSM | Global System for Mobile communications |
| I-RNTI | Inactive-Radio Network Temporary Identifier |
| ID | Identifier/Identity |
| IE | Information Element |
| LDPC | Low-Density Parity-Check |
| LTE | Long Term Evolution |
| LTE-A | LTE-Advanced |
| MAC | Medium Access Control |
| MAC CE | Medium Access Control Control Element |
| MCG | Master Cell Group |
| MeNB | Master eNB |
| mMTC | massive Machine-Type Communication |
| MN | Master Node |
| MR-DC | Multi-RAT Dual Connectivity |
| MSG1 | Message One |
| MSG3 | Message Thress |
| MSGA | Message A |
| MSGB | Message B |
| NACK | Negative Acknowledgment |
| NAS | Non-Access Stratum |
| NB | Node B |
| NG | Next-Generation |
| ng-eNB | next-generation eNB |
| NGC | Next-Generation Core |
| NID | Network Identifier |
| NPN | Non-Public Network |
| NR | New Radio |
| NUL | Normal Uplink |
| OFDM | Orthogonal Frequency-Division Multiplexing |
| P-RNTI | Paging-Radio Network Temporary Identifier |
| PCell | Primary Cell |
| PDCCH | Physical Downlink Control Channel |
| PDCP | Packet Data Convergence Protocol |
| PHY | Physical |
| PLMN | Public Land Mobile Network |
| PRACH | Physical Random Access Channel |
| PRB | Physical Resource Block |
| ProSe | Proximity Service |
| PSCell | Primary Secondary Cell/Primary SCG Cell |
| PUSCH | Physical Uplink Shared Channel |
| RAN | Radio Access Network |
| RAT | Radio Access Technology |
| RB | Radio Bearer |
| Rel-16 | 3GPP Release 16 |
| RLC | Radio Link Control |
| RLF | Radio Link Failure |
| RNA | RAN(-based) Notification Area |
| RNC | Radio Network Controller |
| RRC | Radio Resource Control |
| RS | Reference Signal |
| RSRP | Reference Signal Received Power |
| RSRQ | Reference Signal Receiving Quality |
| SCell | Secondary Cell |
| SCG | Secondary Cell Group |
| SFN | System Frame Number |
| SgNB | Secondary gNB |
| SI | System Information |
| SIB | System Information Block |
| SIB1 | System Information Block Type 1 |
| SL | SideLink |
| SLIV | Start and Length Indicator |
| SMF | Session Management Function |
| SN | Secondary Node |
| SNPN | Stand-Alone Non-Public Network |
| SpCell | Special Cell |
| SRB | Signaling Radio Bearer |
| SRB1 | Signaling Radio Bearer 1 |
| SRB2 | Signaling Radio Bearer 2 |
| SSB | Synchronization Signal Block |
| SUL | Supplementary Uplink |
| TA | Timing Advance/Time Alignment |
| TAT | Time Alignment Timer |
| TB | Transport Block |
| TAG | Timing Advance Group |
| TMSI | Temporary Mobile Subscriber Identity |
| TS | Technical Specification |
| UE | User Equipment |
| UL | Uplink |
| UMTS | Universal Mobile Telecommunications System |
| UPF | User Plane Function |
| URLLC | Ultra-Reliable Low-Latency Communication |
| UTRAN | Universal Terrestrial Radio Access Network |
| V2X | Vehicle-to-Everything |

The following contains specific information related to example implementations of the present disclosure. The drawings and their accompanying detailed description are merely directed to example implementations. However, the present disclosure is not limited to these example implementations. Other variations and implementations of the present disclosure will be obvious to those skilled in the art.

Unless noted otherwise, like or corresponding elements among the drawings may be indicated by like or corresponding reference designators. Moreover, the drawings and illustrations in the present disclosure are generally not to scale, and are not intended to correspond to actual relative dimensions.

For the purpose of consistency and ease of understanding, like features may be identified (although, in some examples, not illustrated) by the same reference designators in the drawings. However, the features in different implementations may differ in other respects and may not be narrowly confined to the implementations illustrated in the drawings.

The phrases “in one implementation,” or “in some implementations,” may each refer to one or more of the same or different implementations. The term “coupled” is defined as connected whether directly or indirectly via intervening components and is not necessarily limited to physical connections. The term “comprising” means “including, but not necessarily limited to” and specifically indicates open-ended inclusion or membership in the disclosed combination, group, series or equivalent. The expression “at least one of A, B and C” or “at least one of the following: A, B and C” means “only A, or only B, or only C, or any combination of A, B and C.”

The terms “system” and “network” may be used interchangeably. The term “and/or” is only an association relationship for disclosing associated objects and represents that three relationships may exist such that A and/or B may indicate that A exists alone, A and B exist at the same time, or B exists alone. “A and/or B and/or C” may represent that at least one of A, B, and C exists. The character “/” generally represents that the associated objects are in an “or” relationship.

The terms “if”, “in a case that”, “while”, “when”, “after”, “upon”, and “once” may be used interchangeably. The terms “according to”, “based on”, “through”, and “via” may be used interchangeably.

The terms “determine”, “decide”, and “select” may be used interchangeably. The terms “determined”, “defined”, “configured”, “given”, “predetermined”, “predefined”, “preconfigured”, and “pre-given” may be used interchangeably. The terms “operate”, “implement”, and “perform” may be used interchangeably.

For the purposes of explanation and non-limitation, specific details, such as functional entities, techniques, protocols, standards, and the like, are set forth for providing an understanding of the disclosed technology. In other examples, detailed disclosure of well-known methods, technologies, systems, architectures, and the like are omitted so as not to obscure the present disclosure with unnecessary details.

Persons skilled in the art will immediately recognize that any disclosed network function(s) or algorithm(s) may be implemented by hardware, software or a combination of software and hardware. Disclosed functions may correspond to modules which may be software, hardware, firmware, or any combination thereof.

A software implementation may include computer-executable instructions stored on a computer-readable medium such as memory or other types of storage devices. One or more microprocessors or general-purpose computers with communication processing capability may be programmed with corresponding executable instructions and perform the disclosed network function(s) or algorithm(s).

The microprocessors or general-purpose computers may include Application-Specific Integrated Circuits (ASICs), programmable logic arrays, and/or using one or more Digital Signal Processors (DSPs). Although some of the disclosed implementations are oriented to software installed and executing on computer hardware, alternative example implementations implemented as firmware, as hardware, or as a combination of hardware and software are well within the scope of the present disclosure.

The computer-readable medium may include, but is not limited to, Random Access Memory (RAM), Read-Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture such as an LTE system, an LTE-A system, an LTE-Advanced Pro system, or a 5G NR RAN may typically include at least one BS, at least one UE, and one or more optional network elements that provide connection within a network. The UE may communicate with the network such as a CN, an EPC network, an E-UTRAN, an NGC, a 5GC, or an internet via a RAN established by one or more BSs.

A UE may include, but is not limited to, a mobile station, a mobile terminal or device, or a user communication radio terminal. The UE may be a portable radio equipment that includes, but is not limited to, a mobile phone, a tablet, a wearable device, a sensor, a vehicle, or a Personal Digital Assistant (PDA) with wireless communication capability. The UE may be configured to receive and transmit signals over an air interface to one or more cells in a RAN.

The BS may be configured to provide communication services according to at least an RAT such as Worldwide Interoperability for Microwave Access (WiMAX), Global System for Mobile communications (GSM that is often referred to as 2G), GSM Enhanced Data rates for GSM Evolution (EDGE) RAN (GERAN), General Packet Radio Service (GPRS), Universal Mobile Telecommunication System (UMTS that is often referred to as 3G) based on basic Wideband-Code Division Multiple Access (W-CDMA), High-Speed Packet Access (HSPA), LTE, LTE-A, evolved/enhanced LTE (eLTE) that is LTE connected to 5GC, NR (often referred to as 5G), and/or LTE-A Pro. However, the scope of the present disclosure is not limited to these protocols.

The BS may include, but is not limited to, an NB in the UMTS, an eNB in LTE or LTE-A, an RNC in UMTS, a BSC in the GSM/GERAN, an ng-eNB in an E-UTRA BS in connection with 5GC, a gNB in the 5G-RAN (or in the 5G Access Network (5G-AN)), or any other apparatus capable of controlling radio communication and managing radio resources within a cell. The BS may serve one or more UEs via a radio interface.

The BS may be operable to provide radio coverage to a specific geographical area using a plurality of cells included in the RAN. The BS may support the operations of the cells. Each cell may be operable to provide services to at least one UE within its radio coverage.

Each cell (often referred to as a serving cell) may provide services to serve one or more UEs within its radio coverage such that each cell schedules the DL and optionally UL resources to at least one UE within its radio coverage for DL and optionally UL packet transmissions. The BS may communicate with one or more UEs in the radio communication system via the plurality of cells.

A cell may allocate SL resources for supporting ProSe, LTE SL services, and/or LTE/NR V2X services. Each cell may have overlapped coverage areas with other cells.

In MR-DC cases, the primary cell of an MCG or an SCG may be called an SpCell. A PCell may refer to the SpCell of an MCG. A PSCell may refer to the SpCell of an SCG. An MCG may refer to a group of serving cells associated with the MN, including the SpCell and optionally one or more SCells. An SCG may refer to a group of serving cells associated with the SN, including the SpCell and optionally one or more SCells.

As disclosed above, the frame structure for NR supports flexible configurations for accommodating various next-generation (e.g., 5G) communication requirements such as eMBB, mMTC, and URLLC, while fulfilling high reliability, high data rate and low latency requirements. The OFDM technology in the 3GPP may serve as a baseline for an NR waveform. The scalable OFDM numerology such as adaptive sub-carrier spacing, channel bandwidth, and CP may also be used.

Two coding schemes are considered for NR, specifically LDPC code and Polar Code. The coding scheme adaption may be configured based on channel conditions and/or service applications.

At least DL transmission data, a guard period, and an UL transmission data should be included in a transmission time interval (TTI) of a single NR frame. The respective portions of the DL transmission data, the guard period, and the UL transmission data should also be configurable (e.g., based on the network dynamics of NR). SL resources may also be provided in an NR frame to support ProSe services, V2X services (e.g., E-UTRA V2X SL communication services) or SL services (e.g., NR SL communication services). In contrast, SL resources may also be provided in an E-UTRA frame to support ProSe services, V2X services (e.g., E-UTRA V2X SL communication services) or SL services (e.g., NR SL communication services).

Multiple PLMNs may operate on an unlicensed spectrum. Multiple PLMNs may share the same unlicensed carrier. The PLMNs may be public or private. Public PLMNs may be (but not limited to) operators or virtual operators, which provide radio services to public subscribers. Public PLMNs may own a licensed spectrum and support an RAT on the licensed spectrum as well. Private PLMNs may be (but not limited to) micro-operators, factories, or enterprises, which provide radio services to its private users (e.g., employees or machines). Public PLMNs may support more deployment scenarios (e.g., CA between licensed band NR (PCell) and NR-Unlicensed (NR-U) (SCell), DC between licensed band LTE (PCell) and NR-U (PSCell), stand-alone NR-U, an NR cell with DL in an unlicensed band and UL in a licensed band, DC between licensed band NR (PCell) and NR-U (PSCell)). Private PLMNs may support (but not limited to) stand-alone unlicensed RAT (e.g., stand-alone NR-U).

Any two or more than two of the following sentences, paragraphs, (sub)-bullets, points, actions, behaviors, terms, alternatives, aspects, examples, or claims described in the following disclosure may be combined logically, reasonably, and properly to form a specific method.

Any sentence, paragraph, (sub)-bullet, point, action, behaviors, terms, alternatives, aspects, examples, or claims described in the following disclosure may be implemented independently and separately to form a specific method.

Dependency (e.g., “based on”, “more specifically”, “preferably”, “In one embodiment”, “In some implementations”, “In one alternative”, “In one example”, “In one aspect”, or etc.) in the following disclosure is just one possible example which may not restrict the specific method.

Example description of some selected terms, examples, embodiments, implementations, actions, and/or behaviors used in the present disclosure are given as follows.

The terms “network”, “RAN”, “cell”, “camped cell”, “serving cell”, “BS”, “gNB”, “eNB” and “ng-eNB” may be used interchangeably. In some implementations, some of these items may refer to the same network entity.

Cell: A cell may be a radio network object that may be uniquely identified by a UE from a (cell) identification that is broadcast over a geographical area from one UTRAN Access Point. The Cell may be either in an FDD or a TDD mode.

Serving cell: For a UE in an RRC connected state (e.g., RRC_CONNECTED state) that is not configured with CA or DC, there may be only one serving cell, which may be referred to as a PCell. For a UE in the RRC_CONNECTED state that is configured with CA or DC, the term “serving cells” may be used to denote a set of cells including SpCell(s) and all SCells. For example, the serving cell may be a PCell, a PSCell, or an Scell, as described, e.g., in the 3GPP TS 38.331.

A UE (operating) in an RRC connected state (e.g., RRC_CONNECTED state) may be referred to as an RRC_CONNECTED UE. A UE (operating) in an RRC idle state (e.g., RRC_IDLE state) may be referred to as an RRC_IDLE UE. A UE (operating) in an RRC inactive state (e.g., RRC_INACTIVE state) may be referred to as an RRC_INACTIVE UE.

SpCell: For a DC operation, the term SpCell may refer to a PCell of an MCG or a PSCell of an SCG. Otherwise, the term SpCell may refer to the PCell.

MR-DC: An MR-DC may be DC between E-UTRA and NR nodes, or between two NR nodes. The MR-DC may include EN-DC, NR-E-UTRA Dual Connectivity (NE-DC), NG-RAN E-UTRA-NR Dual Connectivity (NGEN-DC), and NR-NR Dual Connectivity (NR-DC) (mode).

MCG: An MCG may be, in MR-DC, a group of serving cells associated with an MN including an SpCell (e.g., PCell) and optionally one or more SCells.

MN: An MN may be, in MR-DC, a radio access node that provides a control plane connection to a CN. The MN may be a Master eNB (in EN-DC), a Master ng-eNB (in NGEN-DC), or a Master gNB (in NR-DC and NE-DC).

SCG: An SCG may be, in MR-DC, a group of serving cells associated with an SN including an SpCell (e.g., PSCell) and optionally one or more SCells.

SN: An SN may be, in MR-DC, a radio access node, with no control plane connection to a CN, providing additional resources to a UE. The SN may be an en-gNB (in EN-DC), a Secondary ng-eNB (in NE-DC), or a Secondary gNB (in NR-DC and NGEN-DC).

MeNB: An MeNB may be an eNB as a master node associated with an MCG in MR-DC (scenarios).

SgNB: An SgNB may be a gNB as a secondary node associated with an SCG in MR-DC (scenarios).

An upper layer of a UE may refer to (but is not limited to) a NAS layer, an RRC layer, a PDCP layer, an RLC layer, or a MAC layer.

A lower layer of a UE may refer to (but is not limited to) an RRC layer, a PDCP layer, an RLC layer, a MAC layer, or a PHY layer.

An AS layer of a UE may refer to (but is not limited to) an RRC layer, a PDCP layer, an RLC layer, a MAC layer, and a PHY layer.

A CN may include (but is not limited to) at least one of an AMF, a UPF, and an SMF.

SI may refer to an MIB, SIB1, and/or other SI. Minimum SI may include an MIB and SIB1. Other SI may refer to SIB3, SIB4, SIB5, and other SIB(s) (e.g., SNPN-specific SIB, PNI-NPN-specific SIB).

Dedicated signaling may refer to (but is not limited to) RRC message(s). For example, the RRC message(s) may include an RRC (Connection) Setup Request message, RRC (Connection) Setup message, RRC (Connection) Setup Complete message, RRC (Connection) Reconfiguration message, RRC Connection Reconfiguration message including the mobility control information, RRC Connection Reconfiguration message without the mobility control information inside, RRC Reconfiguration message including the configuration with sync, RRC Reconfiguration message without the configuration with sync inside, RRC (Connection) Reconfiguration complete message, RRC (Connection) Resume Request message, RRC (Connection) Resume message, RRC (Connection) Resume Complete message, RRC (Connection) Reestablishment Request message, RRC (Connection) Reestablishment message, RRC (Connection) Reestablishment Complete message, RRC (Connection) Reject message, RRC (Connection) Release message, RRC System Information Request message, UE Assistance Information message, UE Capability Enquiry message, and UE Capability Information message. RRC message may be one kind of dedicated signaling. The UE may receive the RRC message from the network via unicast/broadcast/groupcast.

The disclosed mechanisms/methods may be applied to any RAT. The RAT may include (but is not limited to) NR, NR-U, LTE, E-UTRA connected to 5GC, LTE connected to 5GC, E-UTRA connected to EPC, and LTE connected to EPC. The disclosed mechanisms/methods may be applicable to the UEs in public networks, or in private networks (e.g., NPN, SNPN, and PNI-NPN).

The disclosed mechanisms/methods may be used for licensed frequency and/or unlicensed frequency.

Generally, the disclosed mechanisms/methods may be applicable to (but is not limited to) the PCell and the UE. In addition, the mechanisms described in the present disclosure may be applicable to the PSCell and the UE.

In the present disclosure, the terms “SDT procedure” and “SDT session” may be used interchangeably. The terms “operation carrier”, “operating carrier”, “operation UL carrier”, and “operating UL carrier” may be used interchangeably. The terms “CG-based SDT procedure” may also be referred to as “CG-SDT procedure” in the present disclosure. The terms “RA-based SDT procedure” may also be referred to as “RA-SDT procedure” in the present disclosure.

### SUL Carrier

To improve UL coverage for high frequency scenarios, one or more SUL carriers may be configured to the UE (e.g., to extend the coverage area of the (normal) UL carrier to the coverage area of the SUL carrier). With the support of the SUL carrier(s), the UE's loading (e.g., loading on UL power consumption or modulation and coding scheme) in UL transmission may be relieved. With the SUL carrier(s), the UE may be configured with (at least) two ULs (e.g., NUL and SUL carriers) for (or associated with) one DL of the same cell. The UE may operate within one or more of the coverage areas of (or associated with) the cell.

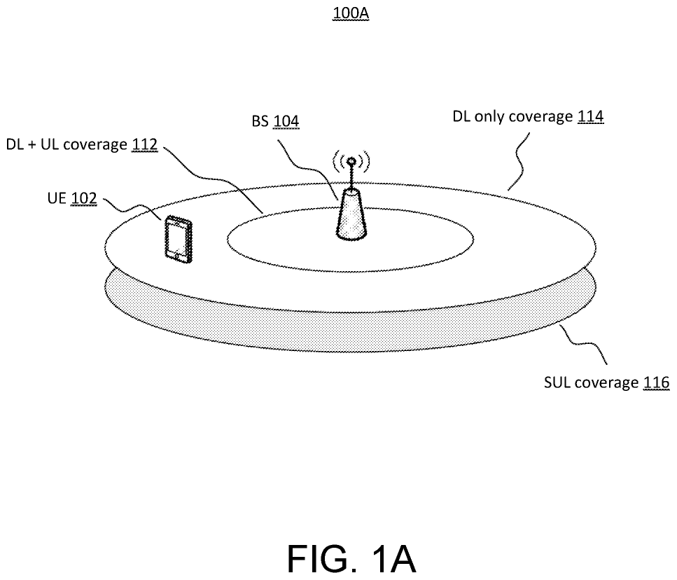

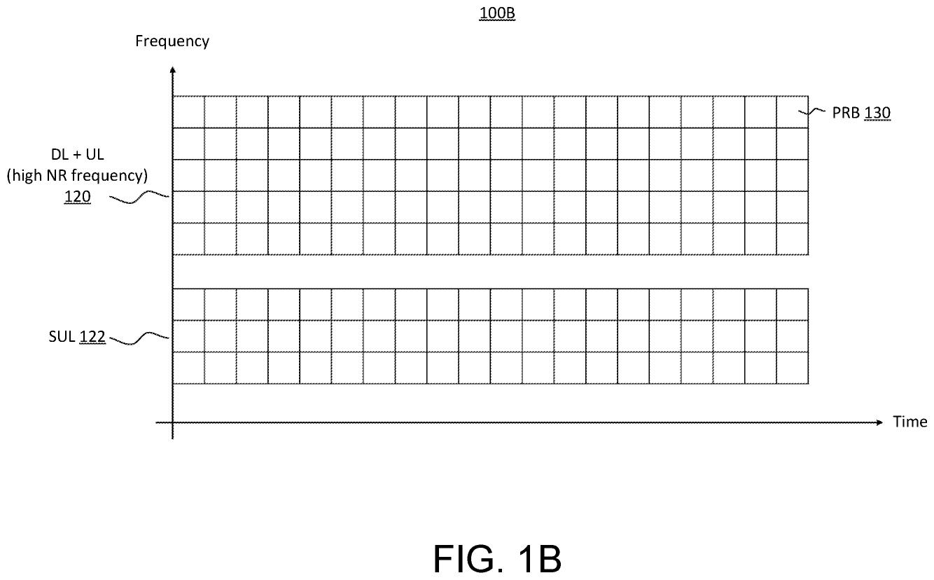

FIG. 1A is a schematic diagram 100A illustrating the coverage areas of an NUL carrier and an SUL carrier, according to an example implementation of the present disclosure.

FIG. 1B illustrates a schematic diagram 100B regarding frequency ranges of (frequency or physical) resources allocated to an SUL carrier and an NUL carrier according to an example implementation of the present disclosure.

As shown in FIG. 1A, BS 104 (e.g., a gNB or eNB) has (or is associated with) three (service) coverage areas including DL+UL coverage area 112, DL only coverage area 114, and SUL coverage area 116. DL+UL coverage area 112 may cover a smaller area than DL only coverage area 114 and SUL coverage area 116.

As shown in FIG. 1A, UE 102 is located within DL only coverage area 114 as well as SUL coverage area 116. Accordingly, UE 102 may (only) be able to transmit UL data using the SUL carrier while the UE is in an RRC inactive state.

As shown in FIG. 1B, two (component) carriers are configured (e.g., with multiple BWPs) on a time-frequency region. PRB 130 is allocated to DL+UL 120. DL+UL 120 is corresponding to DL+UL coverage area 112 and is associated with higher frequency bands on the time-frequency region. SUL 122 is corresponding to SUL coverage area 116 and is associated with relatively lower frequency bands (e.g., compared to DL+UL 120) on the time-frequency region. That is, the UL carrier (e.g., DL+UL) is allocated to frequency resources that have higher frequency than the frequency resources allocated to the SUL carrier.

### RRC Inactive State

According to 3GPP TS 38 series specifications (e.g., TS 38.300 and TS 38.331), the RRC inactive state (e.g., RRC_INACTIVE state) is a state in which the UE remains in the CM-CONNECTED state and may move within an area configured by an NG-RAN (e.g., the RNA) without notifying the NG-RAN. In the RRC inactive state, the last serving gNB node keeps the UE context and the UE-associated NG connection with the serving AMF and UPF.

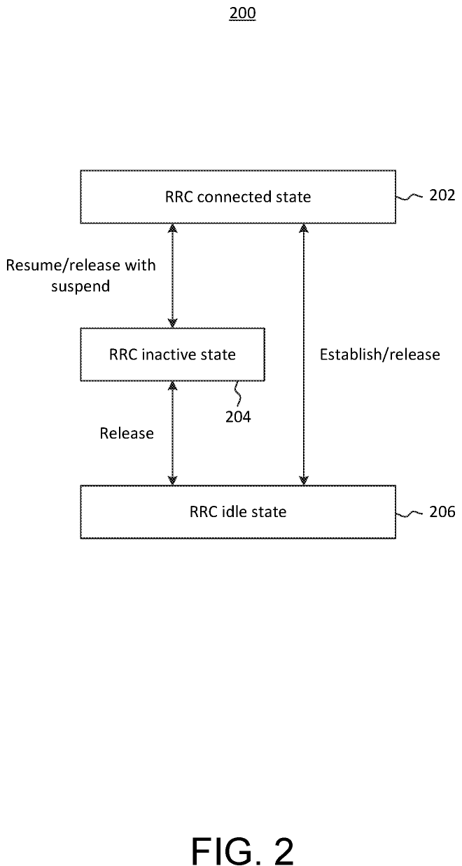

FIG. 2 is a schematic diagram 200 illustrating the RRC state transition in NR, according to an example implementation of the present disclosure. It should be noted that a UE may have only one RRC state in NR at one time.

The network may initiate an RRC connection release procedure by transmitting an RRCRelease message (with an IE suspendConfig) to the UE. The RRC connection release procedure may be initiated for the following purposes:
Transition the UE that is in RRC connected state 202 (e.g., RRC_CONNECTED) to RRC idle state 206 (e.g., RRC_IDLE).
Transition the UE that is in RRC connected state 202 to RRC inactive state 204 (e.g., (only) if the SRB2 and at least one DRB is setup in RRC connected state 202).
Keep the UE in RRC inactive state 204 when the UE determines (or tries) to resume.
Transition the UE that is in RRC inactive state 204 to RRC idle state 206 when the UE determines (or tries) to resume.

In some implementations, the network may transmit an RRCRelease message without an IE suspendConfig to transition the UE from RRC connected state 202 or RRC inactive state 204 to RRC idle state 206. In some other implementations, the network may transmit an RRCRelease message with an IE suspendConfig to transition the UE from RRC connected state 202 or RRC inactive state 204 to RRC inactive state 204.

The RRC inactive state may support (but is not limited to) at least one of the following functions: PLMN selection, broadcast of SI, cell reselection mobility, paging initiated by an NG-RAN (e.g., RAN paging), RNA managed by the NG-RAN, DRX for RAN paging configured by the NG-RAN, 5GC-NG-RAN connection (both Control and User-planes) established for the UE, the UE AS context stored in the NG-RAN and the UE, and the NG-RAN that knows the RNA to which the UE belongs.

For NR connected to 5GC, the UE ID “I-RNTI” may be used to identify the UE context in the RRC inactive state. The I-RNTI provides a new NG-RAN node a reference to the UE context in the old NG-RAN node. How the new NG-RAN node is able to resolve the old NG-RAN ID from the I-RNTI is a matter of proper configuration in the old and new NG-RAN nodes. Some typical partitioning of a 40 bit I-RNTI may assume the following contents:
UE specific reference: may include a reference to the UE context within a logical NG-RAN node.
NG-RAN node address index: may include information to identify the NG-RAN node that has allocated the UE specific part.
PLMN-specific information: may include information supporting network sharing deployments, and/or providing an index to the PLMN ID part of the Global NG-RAN node ID.
SNPN-specific information: SNPN may include a small PLMN configured by the operator. Each SNPN may be identified by a unique SNPN ID (e.g., an ID of an SNPN including a PLMN ID and an NID combination). A CG configuration may be associated with an SNPN ID.

### UE Inactive AS Context

The UE inactive AS Context may be stored when the connection is suspended (e.g., when the UE is in the RRC inactive state) and may be restored when the connection is resumed (e.g., when the UE transitions from the RRC inactive state to the RRC connected state).

The suspension of the RRC connection may be initiated by the network. When the RRC connection is suspended, the UE may store the UE inactive AS context and any configuration (e.g., CG configuration) received from the network and transition to the RRC inactive state. If the UE is configured with SCG, the UE may release the SCG configuration upon initiating an RRC Connection Resume procedure. The RRC message to suspend the RRC connection may be integrity protected and ciphered.

The resumption of the suspended RRC connection may be initiated by upper layers (e.g., of the UE) when the UE needs to transition from the RRC inactive state to the RRC connected state, or by an RRC layer to perform an RNA update, or by a RAN paging from an NG-RAN. When the RRC connection is resumed, the network may configure the UE according to the RRC connection resume procedure based on the stored UE inactive AS context and any RRC configuration received from the network. The RRC connection resume procedure may reactivate the AS security and reestablish SRB(s) and/or DRB(s).

In response to a request to resume the RRC connection, the network may resume the suspended RRC connection and instruct the UE to transition to the RRC inactive state, or reject the request to resume and instruct the UE to transition to the RRC inactive state (with a waiting timer), or directly resuspend the RRC connection and instruct the UE to transition to the RRC inactive state, or directly release the RRC connection and instruct the UE to transition to the RRC inactive state, or instruct the UE to initiate NAS level recovery (e.g., the network transmits an RRC setup message).

In the RRC inactive state, a UE specific DRX may be configured by upper layers or by the RRC layer (e.g., of the UE), UE controlled mobility may be based on a network configuration, the UE may store the UE inactive AS context, and an RNA may be configured by the RRC layer.

Furthermore, the UE may perform at least one of the following actions in the RRC inactive state:
Monitor Short Messages transmitted with P-RNTI over DCI.
Monitor a Paging channel for CN paging using 5G-S-TMSI and RAN paging using fullI-RNTI.
Perform neighboring cell measurements and cell (re)selection.
Perform RNA updates periodically and when moving outside the configured RNA.
Acquire SI and send SI request (if configured).

### SDT (e.g., During an RRC Inactive State)

NR supports the RRC inactive state (e.g., RRC_INACTIVE state), and UEs with infrequent (e.g., periodic and/or non-periodic) data transmission are generally maintained by the network in the RRC inactive state. Until Rel-16, data transmission has not been supported in the RRC inactive state. Hence, the UE may need to resume the connection (e.g., move to the RRC connected state (e.g., RRC_CONNECTED state)) for any DL reception and/or UL data transmission. Connection setup and subsequent release to the RRC inactive state may happen for each data transmission regardless of how small and infrequent the data packets are. This may result in unnecessary power consumption and signaling overhead.

Signaling overhead from the RRC inactive UEs (e.g., due to transmission of small data packets) has been a general problem. As the number of UEs increases in NR, the signaling overhead may become a critical issue not only for the network performance and efficiency but also for the UE battery performance. In general, any device that has intermittent transmission of small data packets in the RRC inactive state may benefit from enabling SDT in the RRC inactive state.

The key enablers for SDT in NR may include the RRC inactive state, 2-step RACH, 4-step RACH, and CG Type-1. Implementations in the present disclosure may build on these building blocks to enable SDT in the RRC inactive state for NR.

### SDT Configuration and SDT Procedure

In some implementations, the UE may receive an SDT configuration via DL UE-specific signaling (e.g., RRCReconfiguration message and/or RRCRelease message) from a serving RAN (e.g., first serving cell associated with the UE). The serving RAN may configure the UL-CG configuration (or CG-PUSCH resource configuration(s)) and/or (UE-specific/common (or cell-specific)) RA resource(s) for the UE to implement SDT after the UE entering (or moving) to the RRC inactive state. That is, SDT may be performed either by an RA procedure with a 2-step RA type or a 4-step RA type (i.e., RA-SDT) or by a CG Type 1 (e.g., CG-SDT). In some implementations, the CG-PUSCH resource and/or the RA resource configuration may be located on the (normal) UL carrier (e.g., UL carrier or NUL carrier) and/or SUL carrier. Then, after receiving the SDT configuration (e.g., while the UE is in the RRC connected state), the UE may store the SDT configuration. The UE enters (or moves) to the RRC inactive state with the stored SDT configuration (e.g., after receiving the RRCRelease message from the first serving cell, which instructs the UE to enter (or move) to RRC inactive state). When some packets (e.g., belonging to the SDT RBs, which may be configured in the SDT configuration) arrive, the UE may initiate (or activate, or perform) an SDT procedure with the second serving cell accordingly. For example, the UE may start the SDT procedure by transmitting the (encoded) packets on the configured UL-CG configuration directly with (or without) transmitting an RRCResume Request message, or by transmitting a preamble first with (or without) attaching (encoded) packets during a 2-step RA procedure triggered as part of the SDT procedure, or by transmitting a preamble as MSG1 and the following RRCResumeRequest message/(encoded) packets in a 4-step RA procedure with the second serving cell.

In some implementations, the second serving cell may be the same as the first serving cell. In some other implementations, the second serving cell may be different from the first serving cell. After the UE initiates an SDT procedure, the serving cell (e.g., the first serving cell or the second serving cell) may continue the SDT by transmitting DL packets to the UE or providing dynamic UL grants to the UE for the subsequent DL or UL packet exchanges. It should be noted that HARQ protocols may be configured as part of the SDT configuration and may be implemented in DL or UL packet exchanges during the SDT procedure.

In some implementations, to complete (or finish) an active SDT procedure, the second serving cell may transmit a second RRCRelease message to instruct the UE to finish the SDT procedure. In some implementations, the UE may keep the stored SDT configuration and stay in the RRC inactive state after receiving the second RRCRelease message to finish the active SDT procedure.

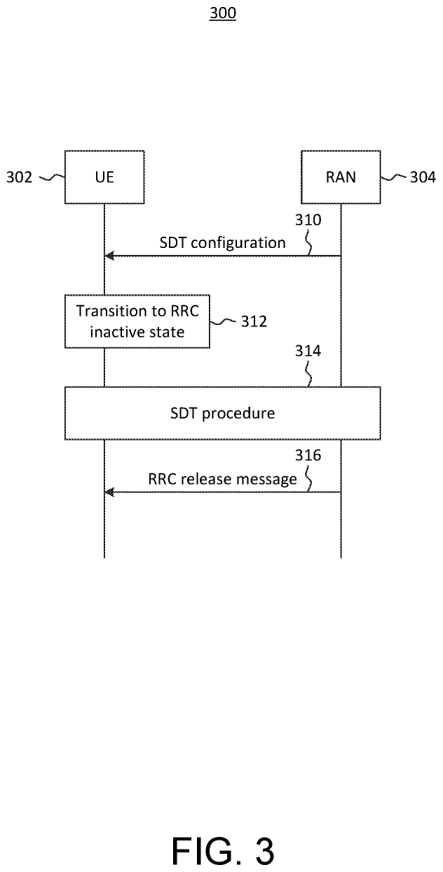

FIG. 3 is a signaling flow diagram 300 illustrating initiation and completion of an SDT procedure, according to an example implementation of the present disclosure.

As shown in FIG. 3, UE 302 may first receive SDT configuration 310 (e.g., via RRCReconfiguration message and/or RRCRelease message) from (serving) RAN 304. After receiving SDT configuration 310 (when UE 302 is in an RRC connected state), UE 302 may transition to RRC inactive state 312. UE 302 may store SDT configuration 310 after transitioning to RRC inactive state 312. Then, UE 302 may initiate (or activate, or perform) SDT procedure 314 with RAN 304 (e.g., when (or after) some packets arrive).

To complete (or finish) SDT procedure 314, RAN 304 may transmit RRC release message 316 (e.g., RRCRelease message) to instruct UE 302 to complete the SDT procedure 314. The UE may keep the stored SDT configuration 310 and stay in RRC inactive state after receiving RRC release message 316.

### UL-CG Configuration (for SDT Configuration) and CG-SDT Procedure

In the UL, the gNB may dynamically allocate resources to the UEs via C-RNTI on PDCCH(s). A UE may (always) monitor the PDCCH(s) in order to receive possible grants for UL transmission when its DL reception is enabled (e.g., an activity that is governed by DRX when configured). When CA is configured, the same C-RNTI may apply to all serving cells.

In addition, with CGs, the gNB may allocate UL resources for the initial HARQ transmissions to the UEs. Two types of configured UL grants may be defined as follows:
With Type 1, the RRC layer/RRC entity (in the UE side) directly provides the configured UL grant (including the periodicity). In some impplementations, the RRC layer/RRC entity (in the UE side) provides the configured UL grant based on (broadacst/groupcast or UE-specific dedicated) RRC signaling received from the serving RAN (e.g., serving base station/serving gNB/serving eNB/serving master node/serving secondary node or serving cell, such as special cell(s) or secondary cell(s)).
With Type 2, the RRC layer defines the periodicity of the configured UL grant when a PDCCH addressed to CS-RNTI may either signal and activate the configured UL grant, or deactivate it. In some implementations, the PDCCH addressed to CS-RNTI may indicate that the UL grant may be implicitly reused according to the periodicity defined by the RRC, until deactivated.

Type 1 and Type 2 may be configured by the RRC layer per serving cell and per BWP. Multiple configurations may be active simultaneously (only) on different serving cells. For Type 2, activation and deactivation may be independent among the serving cells. For the same serving cell, the MAC entity may be configured with either Type 1 or Type 2.

The RRC layer may configure the following parameters when the CG Type 1 is configured:
cs-RNTI: CS-RNTI for retransmission.
periodicity: periodicity of the CG Type 1.
timeDomainOffset: offset of a resource with respect to SFN=0 in time domain.
timeDomainAllocation: allocation of configured UL grant in time domain which contains startSymbolAndLength (e.g., SLIV in TS 38.214).
nrofHARQ-Processes: the number of HARQ processes for CG.

Upon configuration of a CG Type 1 for a serving cell by upper layers, the MAC entity may perform at least one of the following:
store the UL grant provided by the upper layers as a configured UL grant for the indicated serving cell.
(re)initialize the configured UL grant to start in the symbol according to timeDomainOffset and S (e.g., derived from SLIV as described in TS 38.214), and to reoccur with periodicity.

### RA Procedure, RA Resource Configuration (for SDT Configuration), and RA-SDT Procedure

Based on the 3GPP TS 38 series specifications (e.g., TS 38.300), two types of RA procedures are supported which are as follows:
4-step RA type (with MSG1 (e.g., preamble)).
2-step RA type (with MSGA (e.g., RA preamble and/or PUSCH data)).

Both types of RA procedures support CBRA and CFRA. For example, two types of RA procedures may support 4-step CBRA and 2-step CBRA, respectively.

The UE may select the type of RA procedure at the initiation of the RA procedure based on the network configuration. Selection of the type of RA procedure may be as follows:
when CFRA resources are not configured, an RSRP threshold is used by the UE to select between the 2-step RA type and the 4-step RA type.
when CFRA resources for the 4-step RA type are configured, the UE may select (or perform) the RA procedure with the 4-step RA type.
when CFRA resources for the 2-step RA type are configured, the UE may select (or perform) the RA procedure with the 2-step RA type.

The network may not configure the CFRA resources for 4-step and 2-step RA types at the same time for a BWP. CFRA with the 2-step RA type may be (only) supported for handover.

The MSGA of the 2-step RA type may include a preamble on a PRACH and a payload on a PUSCH. After the MSGA transmission, the UE may monitor for a response (e.g., MSGB) from the network within a configured window. For CFRA, upon receiving the network response, the UE may end the RA procedure. For CBRA, if contention resolution is successful upon receiving the network response, the UE may end the RA procedure; and if a fallback indication is received in the MSGB, the UE may perform the MSG3 transmission and may monitor the contention resolution. If contention resolution is not successful after the MSG3 (re)transmission(s), the UE may go back to the MSGA transmission.

If the RA procedure with the 2-step RA type is not completed after a number of MSGA transmissions, the UE may be configured to switch to CBRA with the 4-step RA type.

For RA in a cell configured with SUL, the network may explicitly signal which carrier to use (e.g., NUL or SUL carrier). In some implementations, the UE may select the SUL carrier in a case that (e.g., if and only if) the measured quality of the DL is lower than a broadcast threshold. The UE may perform carrier selection before selecting from the 2-step and 4-step RA types. The RSRP threshold for selecting from the 2-step and 4-step RA types may be configured separately for the NUL and SUL carriers. Once the carrier is selected, all UL transmissions of the RA procedure may remain on the selected carrier.

When CA is configured, the RA procedure with the 2-step RA type may be (only) performed on a PCell when contention resolution is cross-scheduled by the PCell.

When CA is configured, for the RA procedure with the 4-step RA type, the first three steps of CBRA may occur on the PCell when contention resolution (e.g., step 4 of CBRA) is cross-scheduled by the PCell. The three steps of the CFRA started on the PCell may remain on the PCell. CFRA on an SCell may (only) be initiated by a gNB to establish TA for a secondary TAG. For example, the procedure may be initiated by the gNB with a PDCCH order (step 0) that is sent on a scheduling cell of an activated SCell of the secondary TAG, preamble transmission (step 1) may take place on the indicated SCell, and RAR (step 2) may take place on the PCell. During an RA-SDT procedure, the UE may transmit the pending data in MSG1/MSG3 or the following successive UL packets during a 4-step RA procedure (which may be ended after receiving an RRCRelease message from the serving RAN to finish the active SDT procedure). During the RA-SDT procedure, the UE may transmit the pending data in MSGA and the following UL packets during the 2-step RA procedure (which may be ended after receiving an RRCRelease message from the serving RAN to finish the active SDT procedure).

redirectedCarrierInfo

The IE redirectedCarrierInfo may indicate a carrier frequency (e.g., DL for FDD) and may be used to redirect the UE to an NR or an inter-RAT carrier frequency (e.g., to E-UTRA frequency and to move to an E-UTRAN), by means of cell selection and transitioning to an RRC idle state (e.g., RRC_IDLE state) or an RRC inactive state (e.g., RRC_INACTIVE state). Details may be described in TS 38.304. Based on the UE capability, the network may include the IE redirectedCarrierInfo in an RRCRelease message with an IE suspendConfig if the RRCRelease message is sent in response to an RRCResumeRequest or an RRCResumeRequest1 which may be triggered by the NAS layer (e.g., described in TS 24.501).

### Impact of SUL Carrier(s)

In some implementations, a UE may be configured (e.g., by a (serving) RAN via RRC signaling (e.g., RRCRelease message)) with UL-CG configurations (e.g., one or more (Type 1) CG-PUSCH configurations (for SDT)) on an NUL Carrier. In some implementations, the UE may be configured with UL-CG configurations (e.g., one or more (Type 1) CG-PUSCH configurations (for SDT)) on an SUL Carrier.

In some implementations, the UE may be configured with (e.g., 2-step and/or 4-step) RA resources (for SDT) on the NUL Carrier. In some implementations, the UE may be configured with (e.g., 2-step and/or 4-step) RA resources (for SDT) on the SUL carrier.

From the UE's perspective, the UE may (need to) implement SDT on the NUL carrier and/or SUL carrier during an active SDT procedure. Thus, the pending packet delivery issues when both of the NUL carrier and SUL carrier are (jointly) considered in one or more (active) SDT procedures may need to be solved.

SDT procedure designs/mechanisms by jointly considering SUL and NUL carrier(s) are described as follows.

### UL Carrier Selection

In some implementations, the UE may be configured with a received signal threshold (e.g., a DL-RSRP threshold, T_{UL}) for the UE to determine in which carrier to operate when the UE (determines to) initiate an SDT procedure.

In some implementations, the UE may receive a UE-specific DL-RSRP threshold (e.g., for UL carrier selection to initiate an SDT procedure) via UE-specific dedicated control signaling (e.g., RRCReconfiguration, RACH-ConfigCommon, ConfiguredGrantConfig, and/or RRCRelease message (including suspend configuration)) from the serving cell as part of an SDT configuration. In some implementations, the UE may receive an rsrp-ThresholdSSB-SUL threshold (only) with the UL-CG configuration (for SDT). Then, the UE may (determine to) implement an SDT procedure (e.g., the UE may trigger a CG-SDT procedure via (at least) one CG configuration) on a selected UL carrier (e.g., NUL carrier or SUL carrier) based on the DL measurement result and the given rsrp-ThresholdSSB-SUL threshold. In some implementations, different CG-SDT configurations on different carriers may be configured with different DL-RSRP threshold values.

In some other implementations, the UE may receive a common DL-RSRP threshold (e.g., for UL carrier selection) from the received SIB(s). The UE may receive the SI based on a broadcast approach (e.g., via direct reception or via the SI on-demand procedure) or from the UE-specific dedicated control signaling.

In some other implementations, the UE may receive an rsrp-ThresholdSSB-SUL threshold from a common RACH resource configuration (e.g., rsrp-ThresholdSSB-SUL) and then (determine to) start a (e.g., 2-step or 4-step) RA procedure on a selected (or operating) UL carrier (e.g., NUL or SUL) based on the (common/cell-specific) rsrp-ThresholdSSB-SUL. In some implementations, different RACH resource configurations (e.g., RA-SDT resource configuration) on different carriers may be configured with different DL-RSRP threshold values.

The common DL-RSRP threshold may imply that the threshold is a cell-specific (or RNA-specific) value, and the UEs under the same serving cell coverage (or under the same RNA) may apply the same DL-RSRP threshold for the UL carrier selection (for an SDT procedure). In contrast, the UE-specific DL-RSRP threshold may imply that the serving cell provides a DL-RSRP threshold for the UE and the UE-specific DL-RSRP threshold may overwrite a given common DL-RSRP threshold. In some implementations, a new (e.g., newly received) UE-specific DL-RSRP threshold may overwrite a configured (or stored) UE-specific DL-RSRP threshold at the UE side. In some implementations, a new (e.g., newly received) common DL-RSRP threshold may not overwrite a configured (or stored) UE-specific DL-RSRP threshold. In other words, while receiving SI regarding the SDT configuration, the UE may ignore the common DL-RSRP threshold regarding the UL carrier selection (for SDT) if the UE has (already) stored a UE-specific DL-RSRP threshold (e.g., when both of the common DL-RSRP threshold and the UE-specific DL-RSRP threshold are transmitted by the same serving cell (or base station)).

In some implementations, the UE may (determine to) (re)select the NUL carrier (e.g., associated with the serving cell) if the DL RS strength received from the serving cell is higher than the stored DL-RSRP threshold (e.g., sdt-RSRP-ThresholdSSB-SUL), for example, for a UL carrier selection during an SDT procedure). In some implementations, the UE may (determine to) select the SUL carrier if the DL RS strength received from the serving cell is lower than the stored DL-RSRP threshold (e.g., for a UL carrier selection during an SDT procedure). In some implementations, the UE may (determine to) (re)select the NUL or SUL carrier (e.g., associated with serving cell) if the DL RS strength received from the serving cell is higher (or lower) than the stored DL-RSRP threshold (e.g., for the UL carrier selection during an SDT procedure) when the UE fails to perform UL transmissions via a CG resource (e.g., for a number of times in (consecutive) HARQ NACK receptions, or a number of times in (consecutive) HARQ DTX events (which may imply no HARQ response is received from the serving cell), or a number of times in (consecutive) ARQ NACK receptions in the RLC entity). In some implementations, the UE may (determine to) (re)select the NUL or SUL carrier (e.g., associated with serving cell) if the DL RS strength received from the serving cell is higher (or lower) than the stored DL-RSRP threshold (e.g., for a UL carrier selection during an SDT procedure) when a specific timer (or window) (e.g., SDT failure detection timer or CG response window) expires. In some implementations, the UE may (determine to) (re)select the NUL or SUL carrier (e.g., associated with serving cell) if the DL RS strength received from the serving cell is higher (or lower) than the stored DL-RSRP threshold (e.g., for a UL carrier selection during an SDT procedure) when the UE receives a specific indication from the network. It should be noted that the UE may be triggered to reselect the operating UL carrier during an active SDT procedure.

In some implementations, the UE may (determine to) (re)select the NUL or SUL carrier (e.g., associated with the serving cell) if the DL RS strength (e.g., DL-RSRP value or DL-RSRQ value) received from the serving cell varies by more than a stored DL-RSRP threshold (e.g., during a specific (observation) measurement interval). For example, the difference between the highest value of the DL RS strength received from the serving cell and the lowest value of the DL RS strength received from the serving cell during the specific (observation) measurement interval is higher than a stored DL-RSRP threshold. The stored DL-RSRP threshold may be configured as part of the SDT configuration. In some implementations, the UE may (determine to) (re)select the NUL or SUL carrier (e.g., associated with the serving cell) if the DL RS strength received from the serving cell since the last TA validation is increased (or decreased) by more than a specific threshold. In some implementations, the UE may (determine to) (re)select the NUL or SUL carrier (e.g., associated with the serving cell) if the DL RS strength received from the serving cell is increased (or decreased) by more than a specific threshold when the UE fails to perform UL transmissions via a CG resource (e.g., for a number of times in (consecutive) HARQ NACK receptions, or a number of times in (consecutive) HARQ DTX events (which may imply no HARQ response from the serving cell), or a number of times in (consecutive)_ARQ NACK receptions in the RLC entity). In some implementations, the UE may (determine to) (re)select the NUL or SUL carrier (e.g., associated with the serving cell) if the DL RS strength received from the serving cell is increased (or decreased) by more than a specific threshold when the a specific timer (or window) (e.g., SDT failure detection timer or CG response window) expires at the UE side. In some implementations, the UE may (determine to) (re)select the NUL or SUL carrier (e.g., associated with the serving cell) if the DL RS strength received from the serving cell is increased (or decreased) by more than a specific threshold when the UE receives a specific indication from the network.

In some implementations, the UE may not be allowed (or may be disabled) to change (or reselect) the operating UL carrier (e.g., NUL or SUL carrier) by the UE itself during an initiated (or active) SDT procedure, after the operating UL carrier is determined (or selected) when (or before) the SDT procedure is initiated. In some implementations, whether the UE is allowed (or enabled) to change (or reselect) the operating UL carrier (e.g., NUL or SUL carrier), during an active SDT procedure after the operating UL carrier is determined (or selected) when the SDT procedure is initiated, may be determined based on an indication (or configuration) received from the network. For example, after (or once) the UE selects an operating UL carrier (e.g., either SUL or NUL) and then performs an SDT procedure, the switching of the UL carrier may not be triggered during the SDT procedure.

In some implementations, the UE may be configured with a default UL carrier (e.g., SUL carrier or NUL carrier) as part of the SDT configuration. Accordingly, the UE may perform (or initiate) an SDT procedure on the default UL carrier. In some implementations, the default UL carrier (e.g., a common default UL carrier for SDT) may be configured by the serving RAN via broadcast SI. In some implementations, the default UL carrier (e.g., a UE-specific default UL carrier for SDT) may be configured by the serving RAN via a UE-specific dedicated control signaling. In some implementations, a new (e.g., newly configured) UE-specific default UL carrier may overwrite (or replace) a (stored) common default UL carrier for SDT. In some implementations, if the UE is configured with a default UL carrier or a specific UL carrier (e.g., SUL carrier or NUL carrier) as part of the SDT configuration, the UE may not perform the carrier selection during the SDT procedure. In some implementations, if the carrier used for the RA-SDT and/or CG-SDT is explicitly configured (or signaled), the UE may select the configured (or signaled) carrier for performing the RA-SDT and/or CG-SDT procedure. Furthermore, the UE may set the (configured) maximum output power for the UE P_{CMAX} to the (configured) maximum output power for the default carrier of the serving cell c P_{CMAX,f,c}.

In some implementations, the DL-RSRP threshold (e.g., for the NUL or SUL carrier in the SDT procedure) may be the same as a threshold rsrp-ThresholdSSB-SUL. The threshold rsrp-ThresholdSSB-SUL may be configured for the UE to initiate an RA procedure (e.g., an RA procedure triggered for the SDT procedure or an RA procedure triggered for another purpose instead of the SDT procedure (e.g., for initial access)). For example, the threshold rsrp-ThresholdSSB-SUL may be configured in RACH-ConfigCommon. In some other implementations, the DL-RSRP threshold (e.g., for the NUL or SUL carrier in the SDT procedure) may be different from the threshold rsrp-ThresholdSSB-SUL. For example, the threshold rsrp-ThresholdSSB-SUL may be configured in ConfiguredGrantConfig and/or RRCRelease message.

In some implementations, the UE may select the operating UL carrier for an SDT procedure based on the threshold rsrp-ThresholdSSB-SUL (only) if the (SDT-specific) DL-RSRP threshold is not configured by the serving RAN and/or serving cell. In some other implementations, the UE may select the operating UL carrier for an SDT procedure by the (SDT-specific) DL-RSRP threshold (e.g., rather than reusing the rsrp-ThresholdSSB-SUL) if the UE receives a (SDT-specific) DL-threshold (e.g., via broadcast SI or via UE-specific DL control signaling (e.g., RRCReconfiguration message)). In some implementations, if the selection of the NUL or SUL carrier (e.g., after the UE determines to perform the SDT) is assumed to be performed before the selection of an RA-based SDT procedure or CG-based SDT procedure, the UE may not (need to) perform the selection of the NUL or SUL carrier after initiating the RA-based SDT procedure. In other words, when the UE initiates a (e.g., 2-step or 4-step) RA procedure for SDT, the UE may not perform the selection of the NUL or SUL carrier during the RA initialization stage if the RA procedure is the RA-based SDT procedure (e.g., initiated for SDT).

In some other implementations, the UE may perform the selection of the NUL or SUL carrier during the RA initialization stage if the RA procedure is a normal RA procedure (e.g., not initiated for SDT). In some implementations, if the selection of the NUL or SUL carrier (e.g., after the UE determines to perform the SDT) is assumed to be performed before the selection of a CG-based SDT procedure, the UE may not (need to) perform the selection of the NUL or SUL carrier after performing initial transmission via the CG resource (e.g., before the end of the SDT procedure).

In some implementations, the DL-RSRP measurement result may be a Layer-1 measurement result. In some other implementations, the DL-RSRP measurement result may be a Layer-3 measurement result. In some implementations, the DL-RSRP measurement result may be a cell-level measurement result. In some implementations, the DL-RSRP measurement result may be measured based on a set of beams (or SSBs) or any subset of operating beams (or SSBs), which may be determined by the UE itself or may be configured by the serving RAN (e.g., serving cell). In some implementations, the DL-RSRP measurement result may be a beam (or SSB) level measurement result.

In some implementations, the UE may be configured with the (separate) UL-CG configurations and/or (separate) RA resources associated with both of the NUL carrier and SUL carrier for SDT. In addition, the UE may be enabled (or allowed) to access the configured SDT resources on both of the NUL and SUL carriers (simultaneously) without switching between the NUL and SUL carriers.

In some implementations, the configured threshold in the present disclosure may be common for (e.g., shared by) different SDT procedures. For example, one common threshold may be configured for control mechanisms of the CG-SDT procedure and RA-SDT procedure. In some other implementations, a dedicated configured threshold may be provided separately to replace the common threshold for a specific SDT procedure (e.g., CG-SDT procedure or RA-SDT procedure) if there is no common threshold. In some other implementations, the UE may reuse the common threshold if the dedicated configured threshold becomes invalid or being released.

### Impact on an RA Procedure

### A Default UL Carrier for an RA Procedure

In some implementations, the serving cell may (explicitly) configure (or indicate to, signal to) the UE which carrier (e.g., NUL carrier or SUL carrier) the UE could (or should) access to initiate an SDT procedure. Based on the configuration, the UE may start an RA procedure to initiate an SDT procedure (only) on the default UL carrier. For example, the UE may initiate an RA procedure by using the RA resources associated with the default (or configured) carrier. The serving cell may transmit the configuration via DL RRC signaling (e.g., via an RRCReconfiguration or RRCRelease message), MAC CE, or DCI.

In some implementations, if the carrier used for the RA-SDT and/or CG-SDT procedure is explicitly configured, the UE may select the configured carrier for performing the RA procedure during the SDT procedure. Furthermore, the UE may set the (configured) maximum output power for the UE P_{CMAX} to the (configured) maximum output power for the configured carrier f of the serving cell c P_{CMAX,f,c}.

### Resume Cause-Based Selection

In some implementations, the UE may determine (or select) the UL carrier selection approach (e.g., SDT-based UL carrier selection or non-SDT-based UL carrier selection) based on a resume cause (e.g., the purpose of (initiating) an RRC resume procedure). Then, the UE may (determine to) select the NUL or SUL carrier based on the SDT-based UL carrier selection in a case that the initiation of the RRC resume procedure is for (or due to) the initiation of an active SDT procedure. In some other implementations, the UE may (determine to) select the NUL or SUL carrier based on the non SDT-based UL carrier selection (e.g., the conventional UL carrier selection procedure (e.g., the NUL or SUL selection procedure described in the TS 38 series specifications (e.g., TS 38.304 and TS 38.331)) in a case that the initiation of the RRC resume procedure is not for (or due to) the initiation of an active SDT procedure.

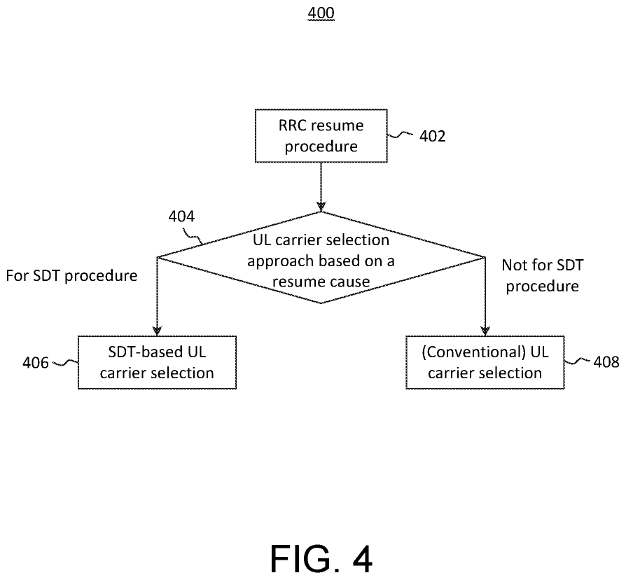

FIG. 4 is a flowchart 400 illustrating a UL carrier selection approach based on a resume cause, according to an example implementation of the present disclosure. As shown in FIG. 4, the UE may initiate RRC resume procedure 402 (e.g., with or without transmitting an RRCResumeRequest message to its serving cell). The UE may perform the UL carrier selection approach based on a resume cause 404 to select one of SDT-based UL carrier selection and non-SDT-based UL carrier selection after initiating RRC resume procedure 402. The UE may perform SDT-based UL carrier selection 406 in a case that (or after determining that) the purpose of (initiating) the RRC resume procedure is for the SDT procedure. The UE may perform non-SDT-based UL carrier selection 408 in a case that (or after determining that) the purpose of (initiating) the RRC resume procedure is not for the SDT procedure.

It should be noted that (the procedure shown in) FIG. 4 may also mean that the UE may change (or switch) its UL carrier selection approach when (or after) the UE fallbacks from an SDT procedure to the conventional RRC resume procedure (e.g., the UE may first initiate an SDT procedure for packet delivery during the RRC inactive state and then the UE may fallback to the conventional RRC resume procedure).

### UE-Autonomous UL Carrier Switch

In some implementations, the UE may be enabled (or configured, allowed), via dedicated RRC signaling (e.g., RRCRelease message) and/or broadcast SI (e.g., SIB), to change (or switch) the operating UL carrier (e.g., the UE may switch between the NUL and SUL carriers) during an active SDT procedure directly by the UE (e.g., based on the UE's determination). For example, the UE may switch from the selected (or operating) UL carrier to another UL carrier. The UE may switch from the other UL carrier (back) to the selected (or operating) UL carrier. In some implementations, if the UE is disabled (or not configured, or not allowed) to change (or switch) the operating UL carrier, the UE may (only) rely on the (SUL/NUL) indication from the UL grant/DL assignment for carrier switching during the active SDT procedure. In some implementations, if the UE is disabled (or not configured, not allowed) to change (or switch) the operating UL carrier, the UE may (only) select the carrier (once) for an SDT procedure (e.g., the UE may select the UL carrier (once) when the UE initiates the SDT procedure). It should be noted that the disabling of switching the operating UL carrier may imply that the UE is disabled to switch from the operating UL carrier to another UL carrier by the UE itself, but the UE may be enabled (or configured, allowed) to switch from the other carrier (back) to the operating UL carrier (e.g., by the UE itself or based on an instruction from the network).

In some other implementations, the UE may determine which UL carrier to switch (and to access the UL-CG configuration and/or RA configuration associated with the switched (or selected) UL carrier) based on the (DL-RSRP) signaling threshold. That is, the signaling may imply that the UE may not access the radio resources on both the NUL and SUL carriers simultaneously.

### Impact of Fallback

In some implementations, the UE may switch (or reselect) the operating UL carrier when the UE fallbacks to a conventional RRC procedure (e.g., RRC resume procedure, RRC establishment procedure). The fallback scenario may be as follows:
a CG-SDT procedure fallbacks to the conventional RRC procedure.
an RA-SDT procedure fallbacks to the conventional RRC procedure.
a CG-SDT procedure fallbacks to an RA-SDT procedure.

In some implementations, the UE may receive fallback instruction(s) from the serving cell (or RAN) after the UE initiates an SDT procedure. The fallback instruction(s) may instruct the UE to fallback to a non-SDT procedure (e.g., the serving cell may instruct the UE to fallback to conventional RRC resume procedure, RRC establishment procedure, or RRC reestablishment procedure, and the UE may fallback to initiate an RA procedure for the transmission of RRCResumeRequest message/RRCSetupRequest message/RRCReestablishmentRequest message).

The serving cell may transmit the fallback instruction(s) via at least one of the following messages:
A RAR message;
A fallback RAR message (e.g., fallbackRAR); or
DCI

In some implementations, the UE may receive a RAR message. The RAR message (or information included in the RAR message) may instruct the UE to fallback to the non-SDT procedure after the UE transmits a (e.g., UE-specific) preamble (e.g., MSG1) during a 4-step RA procedure. In some other implementations, the UE may receive the RAR message, which instructs the UE to fallback to the non-SDT procedure, after the UE transmits a (e.g., UE-specific) preamble with data payload (e.g., MSGA, the payload message may include an RRCRessumeRequest message and/or one (or more) small data TB(s)) during a 2-step RA procedure. In some implementations, the UE may receive the RAR message, which instructs the UE to fallback to the non-SDT procedure, after the UE transmits an (e.g., UE-specific) RRCResumeRequest message with data payload (e.g., which may include the RRCRessumeRequest message and/or one (or more) small data TB(s)) by accessing the configured CG-PUSCH resources. It should be noted that the 4-step RA procedure may be a slice-specific 4-step RA procedure or a conventional 4-step RA procedure. It should be noted that the 2-step RA procedure may be a slice-specific 2-step RA procedure or a conventional 2-step RA procedure.

In some implementations, the UE may receive the fallback RAR message, which instructs the UE to fallback to the non-SDT procedure, after the UE transmits a (e.g., UE-specific) preamble (e.g., MSG1) during a 4-step RA procedure. In some other implementations, the UE may receive the fallback RAR message, which instructs the UE to fallback to the non-SDT procedure, after the UE transmits a (e.g., UE-specific) preamble with data payload (e.g., MSGA, the payload message may include an RRCRessumeRequest message and/or one (or more) small data TB(s)) during a 2-step RA procedure. In some implementations, the UE may receive the fallback RAR message, which instructs the UE to fallback to the non-SDT procedure, after the UE transmits an (e.g., UE-specific) RRCResumeRequest message with data payload (e.g., which may include the RRCRessumeRequest message and/or one (or more) small data TB(s)) by accessing the configured CG-PUSCH resources.

In some implementations, the UE may receive the DCI message, which instructs the UE to fallback to the non-SDT procedure, after the UE transmits a (e.g., UE-specific) preamble (e.g., MSG1) during a 4-step RA procedure. In some other implementations, the UE may receive the DCI message, which instructs the UE to fallback to the non-SDT procedure, after the UE transmits a (e.g., UE-specific) preamble with data payload (e.g., MSGA, the payload message may include an RRCRessumeRequest message and/or one (or more) small data TB(s)) during a 2-step RA procedure. In some implementations, the UE may receive the DCI message, which instructs the UE to fallback to the non-SDT procedure, after the UE transmits an (e.g., UE-specific) RRCResumeRequest message with data payload (e.g., which may include the RRCRessumeRequest message and/or one (or more) small data TB(s)) by accessing the configured CG-PUSCH resources.

In some implementations, the UE may stop the SDT procedure (e.g., and (then) stop (or release) the running SDT failure timer) and (then) initiate the non-SDT procedure based on a received fallback instruction (e.g., after receiving the fallback instruction from the serving cell).

In some implementations, the UE may move (e.g., from the RRC inactive state) to an (NR or LTE) RRC idle state after receiving the fallback instruction.

In some implementations, the UE may terminate the SDT procedure after receiving the fallback instruction.

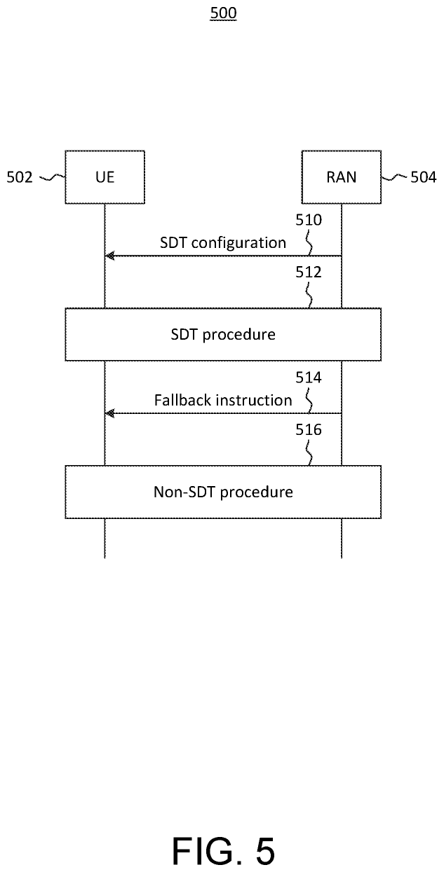

FIG. 5 is a signaling flow diagram 500 illustrating an initiation and fallback mechanism of an SDT procedure, according to an example implementation of the present disclosure. As shown in FIG. 5, UE 502 may first receive SDT configuration 510 from (serving) RAN 504. SDT configuration 510 may include a CG-PUSCH resource configuration and/or an RA resource configuration (specific) for UE 502 to implement SDT while UE 502 is staying in an RRC inactive state. Then, UE 502 may initiate SDT procedure 512 based on the received SDT configuration 510. UE 502 may also (re)start (or set) an SDT failure detection timer (e.g., to zero) when SDT procedure 512 is (re)initiated. During the active SDT procedure 512, UE 502 may receive (at least) one fallback instruction 514 from RAN 504 to instruct UE 502 to fallback to non-SDT procedure 516 (e.g., conventional RRC resume procedure, RRC establishment procedure, or RRC reestablishment procedure).

In some implementations, the UE may determine (whether to change) the operating UL carrier (e.g., from the NUL carrier to SUL carrier) based on the fallback instruction (e.g., RAR message, fallback RAR message, or DCI). In some implementations, an explicit indicator (e.g., one bit (such as ‘0’ may represent NUL and ‘1’ may represent SUL), one bit (such as the presence of the bit may represent NUL and the absence of the bit may represent SUL), one bit (such as the presence of the bit may represent SUL and the absence of the bit may represent NUL)) or one specific bit combination in the message) may be predefined (e.g., in the TS 38 series specifications), and the serving cell may transmit the fallback instruction with the given bit (combination) to the UE. After receiving the fallback instruction, the UE may determine (or select) the operating UL carrier (e.g., NUL or SUL carrier) based on the explicit indicator transmitted via the fallback instruction. In some other implementations, the UE may not change the operating UL carrier for the following non-SDT procedure. For example, when the SDT procedure is initiated, the UE may determine (or select) the operating UL carrier (e.g., NUL or SUL carrier) based on the given threshold(s) (e.g., DL-RSRP threshold).

After receiving the fallback instruction, the UE may stay on the same UL carrier for the following non-SDT procedure (e.g., and the UE may not trigger UL carrier reselection for the fallback non-SDT procedure). In some implementations, the UE may not change the operating UL carrier for the following non-SDT procedure if no UL carrier redirect information is provided in the fallback instruction. For example, when the SDT procedure is initiated, the UE may determine the operating UL carrier (e.g., NUL or SUL carrier) based on the given threshold(s) (e.g., DL-RSRP threshold). After receiving the fallback instruction, the UE may stay on the same UL carrier for the following non-SDT procedure (e.g., and the UE may not trigger UL carrier reselection for the fallback non-SDT procedure) if the serving cell does not indicate the operating UL carrier via the fallback instruction.

In some implementations, the UE may determine (or select) the UL carrier for the following non-SDT procedure through implicit approach(s) (e.g., based on a (pre-given) default UL carrier for the non-SDT procedure or based on the physical location of the UL grant provided by the serving cell via the fallback instruction). In some other implementations, the UE may (re)determine the UL operation based on conventional approach (e.g., given threshold (e.g., DL-RSRP threshold) broadcast by the serving cell via one (or more) broadcast SIB1) for the following non-SDT procedure.

In some implementations, the UE may (determine to) fallback to the non-SDT procedure while the initial transmission for SDT (e.g., initial UL transmission via the MSGA/MSG1/MSG3/CG-PUSCH transmission) fails more than (or up to) a configured number of maximum number (of initial UL transmission attempts). In some implementations, the UE may redirect the UL operating carrier (for the following non-SDT procedure) to a default UL carrier (e.g., SUL carrier) or based on the conventional UL carrier determination rules (e.g., based on the comparison result of the DL-RSRP measurement result and a given DL-RSRP threshold configured for UL carrier selection).

### Impact of (SDT) Failure Event

In some implementations, the UE may be enabled (or configured, allowed) to change (or switch) the operating UL carrier (e.g., the UE may switch between the NUL and SUL carrier) by the UE itself when (at least) one of the following failure events happens:
an RLF event happens (e.g., during an active SDT procedure);
a Beam failure event happens (e.g., during an active SDT procedure (e.g., when the UE triggers BFR procedure during the SDT procedure));
The configured SDT resource(s) (e.g., CG-SDT resources and/or RA-SDT resources) become(s) invalid during using the operating UL carrier (and there may be no available SDT resource(s) on the operating UL carrier). In some implementations, the configured SDT resources may be released (or suspended, dropped, cleared) when the SDT resources become invalid. In some implementations, the configured SDT resource(s) may be (considered as) invalid if the configured SDT resource(s) is released (or suspended, dropped, cleared);
The operating UL carrier becomes not available (e.g., the TA-SDT timer expires);
The UE detects the DL-RSRP value from the serving cell is lower than a given threshold (e.g., T_{UL_change}). The threshold T_{UL_change} may be the same as or different from the DL-RSRP threshold (e.g., T_{UL}) for the UE to select the operating UL carrier before (or at the beginning of) an SDT procedure);
SDT failure event.

In some implementations, the UE may (be configured to) operate the SDT procedure on a selected (or operating) UL carrier (e.g., NUL). However, the SDT procedure may fail because of specific condition(s) (e.g., an SDT failure timer may expire at the UE side to reflect that the interruption of DL or UL packet exchange is due to poor channel quality and/or that the UE does not receive the acknowledgment (e.g., dynamic scheduling of DL or UL resource) during the running of a timer (e.g., SDT failure detection timer) which results in the timer expiry).

In some implementations, the UE may move to the RRC idle state (e.g., from the RRC inactive state) after the SDT failure event happens. The stored SDT configuration may be released, and the UE may then trigger an RRC Connection (Re)Establishment procedure to (re)establish an RRC connection with the serving cell. The UE may start the RRC establishment procedure by reselecting the operating UL carrier (e.g., the SUL carrier is reselected to deliver the RRC Setup Request message (or RRC Setup Complete message) for the RRC establishment procedure).

In some implementations, the UE may stay in the RRC inactive state after the SDT failure event happens. The UE may reselect the operating UL carrier for the following (e.g., next) SDT procedure (e.g., without considering the given threshold (e.g., T_{UL}) even though the UE may be (pre)configured with the given threshold as part of the SDT procedure). For example, the UE may switch from the NUL to SUL carrier to (try to) restart a (new) SDT procedure if the SDT failure event happens.

Release (or Suspend) SDT Configuration(s) (e.g., Associated with the UL Carrier on which the Failure Event Happens)

In some implementations, the SDT failure event may happen on a UL carrier (e.g., the (whole) SDT procedure is implemented on a selected UL carrier and then the SDT procedure fails). In this condition, the selected UL carrier may be considered as a failed UL carrier and the UE may (only) suspend (or release) the SDT configuration associated with the failed UL carrier (e.g., the UL-CG configuration and/or the RA resource configuration associated with the UL carrier on which the SDT failure event happens). In some implementations, the UE may not release (or suspend) the SDT configuration(s) which is not associated with the failed UL carrier (e.g., the UL-CG configuration and/or the RA resource configuration which is not associated with the UL carrier on which the SDT failure event happens).

In some other implementations, the UE may release (or suspend) all of the SDT resources configured on both the NUL and SUL carriers (e.g., even the SDT failure event may happen (only) on an operating UL carrier (e.g., either NUL or SUL)).

### Reinitiate SDT Procedure(s)

In some implementations, after an SDT procedure fails on a selected UL carrier (e.g., the NUL carrier), the UE may restart another SDT procedure on another UL carrier (e.g., when an SDT procedure operating on the NUL fails, the UE may switch to the SUL for a new SDT procedure, and vice versa). In addition, the UE may stay on the other UL carrier (e.g., the SUL carrier) for the following SDT procedure if (at least) an SDT procedure has happened on a UL carrier (e.g., the NUL carrier).

In some implementations, if the SDT configuration includes (or covers) radio resources (e.g., CG-PUSCH resources and/or RA resources), the UE may consider that the SDT failure has happened (only) when an SDT attempt fails on both of the NUL and SUL carriers. In some implementations, the UE may move to the RRC idle state (only) when an SDT attempt fails on both of the NUL and SUL carriers. In other words, the UE may (try to) retransmit packets on another UL carrier (e.g., SUL carrier) when the SDT failure event (or failure attempt for packet delivery during an SDT procedure) happens on the UL carrier (e.g., NUL carrier), which is selected by the UE for an active SDT procedure. The failure attempt may include a HARQ NACK message reception event at the UE side (e.g., for UL packet transmission during an SDT procedure) or at the serving cell side (e.g., for DL packet transmission during an SDT procedure).

In some implementations, if the SDT configuration includes (or covers) radio resources (e.g., CG-PUSCH resources and/or RA resources), the UE may consider that the SDT failure has happened even if the active SDT procedure fails (only) on either the NUL or SUL carrier. In some implementations, the UE may move to the RRC idle state (even) when an SDT attempt fails (only) on either the NUL or SUL carrier. In some implementations, the stored SDT configuration may be released regardless of whether the stored resource configuration is associated with the UL carrier on which the SDT failure event happens (or not).

In some implementations, the UE may (determine to) release (or suspend) the SDT resource configuration (e.g., CG configuration for SDT and/or PRACH resource for (the purpose of) SDT) associated with (only) one UL carrier or both of the NUL and SUL carriers based on at least one of the following triggering scenarios (or events) of SDT (procedure) failure event.
A scenario in which the SDT-TAT expires: In some implementations, if the triggering of the SDT failure event is due to (or in response to) the expiry of the SDT-TAT, the UE may release the SDT resources configured on both of the NUL and SUL carriers (e.g., the UL-CG configurations on both of the NUL and SUL carrier). In some implementations, if the triggering of the SDT failure event is due to (or in response to) the expiry of the SDT-TAT, the UE may release the dedicated RA resource on the NUL or SUL carrier. In some other implementations, if the triggering of the SDT failure event is due to (or in response to) the expiry of the SDT-TAT, the UE may not release the dedicated RA resource on the NUL or SUL carrier.
A scenario in which the number of the (consecutive or non-consecutive) (e.g., HARQ) retransmission attempts reach a predefined maximum threshold of (consecutive or non-consecutive) (HARQ) retransmission attempts, where these counted (HARQ) retransmission attempts are implemented on a UL carrier. If the triggering of the SDT failure event is due to (or in response to) this scenario, the UE may (determine to) release (only) the SDT resources of the UL carrier associated with these counted (HARQ) retransmission attempts. In some implementations, the UE may be configured with the predefined maximum threshold of (HARQ) retransmission attempts as part of the SDT configuration.
A scenario in which the number of the (consecutive or non-consecutive) (e.g., HARQ) DTX Events reach a predefined maximum threshold of (consecutive or non-consecutive) (HARQ) DTX events, where these counted (HARQ) DTX events are implemented on a UL carrier. If the triggering of the SDT failure event is due to (or in response to) this scenario, the UE may (determine to) release (only) the SDT resources of the UL carrier associated with these counted (HARQ) DTX events. The UE may be configured with the predefined maximum threshold of (HARQ) DTX events as part of the SDT configuration. The HARQ DTX event may imply that the UE does not receive any HARQ response from the serving cell after transmitting an encoded TB (e.g., which is associated with an HARQ process at the UE side) to the serving cell (e.g., by referring to the SL HARQ DTX event defined in NR PC5 interface).
A scenario in which the number of the (consecutive or non-consecutive) (e.g., ARQ) retransmission attempts reach a predefined maximum threshold of (consecutive or non-consecutive) (ARQ) retransmission attempts, where these counted (ARQ) retransmission attempts are implemented on a UL carrier. If the triggering of the SDT failure event is due to (or in response to) this scenario, the UE may (determine to) release (only) the SDT resources of the UL carrier associated with these counted (ARQ) retransmission attempts. The UE may be configured with the predefined maximum threshold of (ARQ) retransmission attempts as part of the SDT configuration (e.g., as part of the configuration of RLC entity in a DRB or SRB configuration, wherein the DRB/SRB may be allowed to be activated for SDT while the UE stay in the RRC inactive state).
A scenario in which the number of the (consecutive or non-consecutive) failed RA attempts (e.g., during an SDT procedure) reach a predefined maximum threshold of (consecutive or non-consecutive) RA attempts, where these counted RA attempts are implemented on a UL carrier. If the SDT failure event is due to (or in response to) this scenario, the UE may (determine to) release (only) the SDT resources of the UL carrier associated with these counted RA attempts. The UE may be configured with the predefined maximum threshold of RA attempts as part of the SDT configuration.

While the UE is counting the consecutive (or non-consecutive) failure events (e.g., consecutive RA attempts) within (or during) an SDT procedure, the counters may be stopped (or released, reset) when the SDT procedure is stopped (or released, dropped).

In some other implementations, the UE may stop (or release, reset) the counter(s) (or timer(s)) associated with a specific UL carrier (e.g., the NUL or SUL carrier) when the UE switches from a (first) selected UL carrier to another target UL carrier. For example, the UE may switch the operating UL carrier from the NUL carrier to the SUL carrier, and the counter(s) associated with the NUL carrier may be stopped (or released, dropped) while (or upon) the UE switches to the SUL carrier during an SDT procedure.

In some other implementations, the UE may not stop (or release, reset) the counter(s) (or timer(s)) (e.g., related to the SDT failure event identification) while the UE switches from a (first) selected UL carrier to another target UL carrier. For example, the UE may switch the operating UL carrier from the NUL carrier to the SUL carrier, and the counter(s) associated with the NUL carrier may not be stopped (or released, dropped) when (or upon) the UE switches to the SUL carrier during an SDT procedure. The value(s) of the counters associated with the NUL carrier may be suspended when the UE moves to the SUL carrier during the same SDT procedure. In addition, UE may keep counting (or resume) the counters associated with the NUL when the UE moves (back) to the NUL carrier (from the SUL carrier) during the same SDT procedure.

In some implementations, the counters (e.g., the counters associated with the SDT failure event) may not be impacted by UL carrier switch (e.g., from the NUL carrier to SUL carrier, and vice versa). The UE may keep counting the counters after the UL carrier switch.

### Frequency Shift

In some implementations, the serving cell may configure an (optional) IE frequencyShift7p5khz to be associated with a selected (or operating) UL carrier (e.g., SUL carrier). The IE frequency Shift7p5khz may indicate whether the UE needs to (or is enabled to) perform NR UL transmission on the UL carrier which is configured with frequency Shift7p5khz=Enumerated {true} in the UL frequency carrier with a 7.5 KHz shift to the LTE raster. In some implementations, the UE may (need to) perform frequency shift on the operating UL carrier if the UE receives the IE frequencyShift7p5khz=Enumerated {true} associated with the UL carrier. In some other implementations, if the field is absent, the UE may not (need to) perform the frequency shift (for the UL transmission on the corresponding UL carrier).

In some implementations, the IE frequencyShift7p5khz may be provided in broadcast SI (e.g., FrequencyInfoUL-SIB) or in UE-specific control signaling (e.g., Frequency InfoUL).

### FDD-TDD-OrSUL-Optional (Frequency InfoUL-SIB)

The field FDD-TDD-OrSUL-Optional is optionally present, Need R, if the IE FrequencyInfoUL-SIB is for the paired UL for a DL (defined in a Frequency InfoDL-SIB), or if the IE FrequencyInfoUL-SIB is for an unpaired UL (TDD) in certain bands (as described in TS 38.101-1 and TS 38.104), or if the IE FrequencyInfoUL-SIB is for an SUL. The field FDD-TDD-OrSUL-Optional is absent otherwise.

### FDD-TDD-OrSUL-Optional (FrequencyInfoUL)

The field FDD-TDD-OrSUL-Optional is optionally present, Need R, if the IE FrequencyInfoUL is for the paired UL for a DL (defined in a FrequencyInfoDL), or if the IE FrequencyInfoUL is for an unpaired UL (TDD) in certain bands (as described in TS 38.101-1 and TS 38.104), or if the IE FrequencyInfoUL is for an SUL. The field FDD-TDD-OrSUL-Optional is absent, Need R, otherwise.

In some implementations, the IE frequencyShift7p5khz may be configured in an SDT configuration along with the NUL or SUL configuration. In some implementations, the IE frequency Shift7p5khz may be carrier-specific, and NUL carrier and/or SUL carrier may be configured with a frequencyShift7p5khz IE, respectively.

For an SDT radio resource configuration, the serving cell may indicate frequencyShift7p5khz=‘true’ on a UL carrier while the serving cell is configuring (e.g., UE-specific) UL-CG configuration(s) and/or RA Resource on a UL carrier for the UE to implement an SDT procedure on the corresponding UL carrier.

In some implementations, the UE may obtain the IE frequencyShift7p5khz (or determine (e.g., find out) that the IE frequencyShift7p5khz is not present) via UE-specific DL control signaling (e.g., via an RRCRelease/RRCReconfiguration message with the SDT resource configuration when the serving RAN configures UL-CG or RA resources to a UE for SDT procedure(s) after the UE moves to the RRC inactive state).

In some other implementations, the UE may obtain the IE frequency Shift7p5khz via cell-specific common control signaling (e.g., via broadcast SI which provides UL frequency carrier information. In some implementations, the UE may start an SDT procedure with a camped cell via RA procedure. For example, the UE may obtain the IE frequencyShift7p5khz (or determine (e.g., find out) that the IE frequencyShift7p5khz is not present) in the broadcast SI).

In some implementations, whether the UE is able to perform frequency switch on a UL carrier (e.g., NUL or SUL carrier) may be part of the UE capability. The UE capability may change when the UE stays in the RRC inactive state. In some implementations, the UE may support (7.5 KHz) frequency shift on a UL carrier. In some other implementations, the UE may not support (7.5 KHz) frequency shift on the same UL carrier (e.g., because of power saving concern or hardware capability issue).

In some implementations, the UE may ignore a UL carrier (and the UL radio resources) if the UE is configured with radio resource configurations on a UL carrier but the UE could not support (7.5 KHz) frequency shift to the LTE raster on the corresponding UL carrier. In some implementations, the UE may release the SDT resource configuration associated with the UL carrier to which the UE could not access (e.g., because the UE does not support the indicated frequency shift). In some implementations, the UE may not release the SDT resource configuration associated with the UL carrier to which the UE could not access (e.g., because the UE does not support the indicated frequency shift). In some implementations, the UE may suspend (or keep) the SDT resource configuration of the non-accessible UL carrier.

In some implementations, the UE may not expect to be configured with the SDT resource configuration on an associated UL carrier which the UE needs to perform (7.5 KHz) frequency shift for UL packet transmission but the UE does not support frequency shift on the corresponding carrier (e.g., because of UE capability). In other words, during UL carrier selection, the UE may not select a UL carrier (for an SDT procedure initiation) which needs frequency shift for UL packet delivery but the UE does not support frequency shift on the corresponding UL carrier.

Impact of Redirected Carrier (information)

The impact of redirected carrier (information) (e.g., an IE redirectedCarrierInfo) on SDT (procedure) may be as follows.

In some implementations, the UE may receive the IE redirectedCarrierInfo in (or via) an RRCRelease message. The IE redirectedCarrierInfo may instruct (or redirect) the UE to move to a target frequency carrier (e.g., either in DL or UL when the frame structure may be implemented on FDD or TDD).

In some implementations, the IE redirectedCarrierInfo may be configured as part of the SDT configuration at the UE side. In some other implementations, the IE redirectedCarrierInfo may not be configured as part of the SDT configuration at the UE side. In some implementations, the UE may receive the SDT configuration in the RRCReconfiguration and/or RRCRelease message. Thus, part of the SDT configuration may be transmitted in the RRCReconfiguration message and another part of the SDT configuration may be transmitted in the RRCRelease message. In some implementations, the UE may release (or suspend) the stored SDT configuration if the UE receives an IE redirectedCarrierInfo in the RRCRelease message.

In some implementations, the IE redirectedCarrierInfo may instruct (or indicate) the UE to move to an NR frequency carrier (e.g., by providing an NR-ARFCN value) or an E-UTRA frequency carrier (e.g., by providing an E-UTRA-ARFCN value). After receiving the IE redirectedCarrierInfo in the RRCRelease message, the UE may release the stored SDT configuration transmitted to the UE via an RRC message (e.g., RRCReconfiguration message) prior to the reception of the RRCRelease message.

### UL TA

In some implementations, the UE may maintain the same active TAT (e.g., SDT-TAT) to maintain the validity period of the UL-CG configuration configured for SDT procedures.

In some implementations, the running SDT-TAT configured at the UE side may maintain the validity period of the UL-CG configuration on both the NUL and SUL carriers.

In some implementations, the UE may maintain the same running (or active) SDT-TAT associated with the UE after the UE switchs to another operating UL carrier (e.g., from the NUL carrier to the SUL carrier, and vice versa).

### Transmission Power

In some implementations, the UE may be configured with the maximum transmission power (e.g., P-max) allowed on the NUL carrier (of the serving cell) and/or the maximum transmission power allowed on the SUL carrier (of the serving cell), respectively, for the SDT.

In some implementations, the maximum transmission power that the UE may use for SDT (during an SDT procedure) may be (additionally) limited by a parameter (or field) p-NR-FR1 (configured for the cell group) and/or by a parameter p-UE-FR1.

### Successive Transmissions During an SDT Procedure

In some implementations, the UE may select a (operating) UL carrier (e.g., either NUL or SUL) when the UE initiates an SDT procedure for the transmission of preamble (e.g., when the UE starts an SDT procedure by transmitting a preamble), RRCResumeRequest message (e.g., when the UE starts an SDT procedure by transmitting an RRCResumeRequest message), and/or an encoded data packet (e.g., when the UE starts an SDT procedure by transmitting a data packet directly).

In some implementations, after the UE transmits an (or more) encoded packet(s) in the UL direction, the serving cell may instruct the UE to implement successive small packet exchanges by scheduling one or more dynamic UL grants to the UE to continue (or extend, prolong) the active SDT procedure. For example, the serving cell may transmit one (or more) DCI(s) including dynamic UL grant indicating an SUL switch (e.g., from the NUL switch to the SUL) or dynamic UL grant indicating an NUL switch (e.g., from the SUL to the NUL).

CG-PUSCH configuration(s) access (only) in the UL carrier indicated by the serving cell. In some implementations, the UE may be preconfigured with CG-PUSCH configuration(s) on the NUL and/or SUL carrier. In some implementations, during an SDT procedure, if the UE receives DCI to switch from the NUL to the SUL carrier, the UE may be allowed (or enabled) to access the CG-PUSCH configuration(s) (only) associated with the SUL (for the following success packet (re)transmissions) after the UE switches to the SUL in response to (e.g., by obeying) the DCI instruction. In some other implementations, the UE may not be allowed (or disabled) to access the CG-PUSCH configuration(s) associated with the NUL (for the following success packet (re)transmissions in an active SDT procedure) after the UE switches to the SUL in response to (e.g., by obeying) the DCI instruction. In some implementations, during an SDT procedure, if the UE receives DCI to switch from the SUL to the NUL, the UE may be allowed (or enabled) to access the CG-PUSCH configuration(s) (only) associated with the NUL (for the following success packet (re)transmissions) after the UE switches to the NUL in response to (e.g., by obeying) the DCI instruction. In some other implementations, the UE may not be allowed (or disabled) to access the CG-PUSCH configuration(s) associated with the SUL (for the following success packet (re)transmissions in an active SDT procedure) after the UE switches to the NUL in response to (e.g., by obeying) the DCI instruction.

In some implementations, the UE may be preconfigured with CG-PUSCH configuration (also known as UL-CG configuration) on the NUL and/or SUL carrier simultaneously. In some implementations, the UE may be allowed (or enabled) to access the CG-PUSCH configurations associated with the NUL and SUL carriers jointly for (small data) packet (re)transmission within an active SDT procedure. In some implementations, during an active SDT procedure, the serving cell may transmit another instruction (e.g., via a UE-specific RRC signaling, a MAC CE, or via DCI) to enable (or disable) the UE to access both of the NUL and SUL carriers jointly during the ongoing SDT procedure.

In some implementations, the (small data) packet retransmission (e.g., in an active SDT procedure) may cover the DL HARQ and/or UL HARQ retransmission for one or more (small data) packets. In some implementations, the (small data) packet retransmission (e.g., in an active SDT procedure) may cover the DL ARQ and/or UL ARQ retransmission for one or more (small data) packets.

In some implementations, during an SDT procedure, if the MAC entity receives a dynamic UL grant indicating an SUL switch (e.g., switch from NUL to SUL, and vice versa) when an RA procedure is ongoing, the MAC entity may ignore the dynamic UL grant. In some implementations, the RA procedure may be triggered for SDT. In some other implementations, the RA procedure may be triggered when the UL TAT associated with the CG-PUSCH configuration (for SDT procedure) expires and the UE may try to (re)obtain the UL TA for the following SDT procedure.

In some implementations, PUSCH resources and/or PUCCH resources may be configured on the NUL carrier and/or SUL carrier, respectively. In some implementations, the UE may transmit UL packets (on the PUSCH) and HARQ ACK (or NACK) response message(s) (e.g., for the subsequent DL packet transmissions in an SDT procedure) using (or on) the same UL carrier. If the UE is configured to implement SDT procedure on an operating UL carrier (e.g., NUL carrier or SUL carrier), the UE may implement UL packet delivery and HARQ response transmission on the same UL carrier. In other words, the UE may not (be allowed to) implement the UL packet delivery and HARQ response transmission on different UL carriers during an SDT procedure. In some implementations, the PUCCH configuration may (only) be configured for (or on) (only) one of the NUL and SUL carriers, and the UE may (need to) switch its operating UL carrier for HARQ response transmissions (on the configured PUCCH resources).

It should be noted that the disclosed implementations for PUSCH resources configuration may be applicable to RA-SDT resource configuration on the NUL and/or SUL carrier.

### UE Capability

In some implementations, during an SDT procedure, the serving cell may instruct the UE to (dynamically) switch its operating UL carrier (e.g., by transmitting one or more DCIs) (only) when the UE supports dynamic switching between the NUL and SUL carriers. At the UE side, the UE may transmit UE capability information to the serving cell via an IE UECapability Information (e.g., an IE ‘dynamicSwitchSUL={supported}’ may be provided in the IE FeatureSetUplink as part of the IE UECapbility Information to the serving ell). That is, the UE may support dynamic switching between the NUL and SUL carriers (for SDT dynamicSwitchSUL) by receiving the DCI instruction. At the serving cell side, the serving cell may transmit (at least) one DCI for the NUL or SUL switch (during an SDT procedure) (only) when the UE supports dynamic switching between the NUL and SUL carreirs. In some other implementations, the UE may not support dynamic switching between the NUL and SUL carriers if the IE dynamicSwitchSUL={Not supported} or dynamicSwitchSUL is absent in the IE UECapability Information transmitted to the serving cell. During an SDT procedure, the UE may ignore DCI instructing the UE to perform the NUL or SUL switch if the UE does not support dynamic switching. The UE may not expect the serving cell to transmit DCI indicating the dynamic switching to the UE if the UE has not transmitted the IE dynamicSwitchSUL={supported} in the IE UECapabilityInformation to the serving cell.

In some implementations, the serving cell may configure the CG-PUSCH resource configuration and/or RA resource configuration (e.g., CG-SDT resource and/or RA-SDT resource configuration) associated with the SUL carrier (e.g., for (small data) packet transmission and following successive transmission within an SDT procedure) to the UE (only) when the UE has indicated that the UE supports the SUL carrier and/or the UE is capable of implementing frequency shift (e.g., 7.5 KHz to the LTE raster). In other words, the UE may not expect the CG-SDT resource and/or RA-SDT resource associated with the SUL carrier unless the UE has transmitted the UE capability (e.g., the UE supports the SUL carrier operation) to the serving RAN.

### Modification of an SDT Resource

In some implementations, the serving cell may transmit a UE-specific DL control message (e.g., RRCRelease message) to release the SDT configuration (e.g., associated with the NUL or SUL) directly. In addition, an IE (e.g., ReleaseSUL=Yes/No/True; ReleaseNUL=Yes/No/true, the presence or absence of ReleaseSUL) may be configured to instruct the UE to release the SDT resources configuration associated with one of the UL carriers (e.g., CG-PUSCH resource configuration or RA resource configuration for SDT) directly.

### Impact of an RB (Bearer-Based UL Carrier Selection)

In some implementations, the UE may initiate an SDT procedure based on (or in response to) the arrived packets belonging to a specific RB (e.g., DRB, SRB1, or SRB2).

In some implementations, the UE may select a specific UL carrier (e.g., SUL carrier) if the UE triggers the SDT procedure based on (or in response to) a specific RB (e.g., SRB1 or SRB2).

In some other implementations, the UE may select the operating UL carrier (e.g., NUL or SUL carrier) based on other implementations (in the present disclosure) if a (or more) specific RB (e.g., SRB1 or SRB2) is not involved in the initiated SDT procedure (e.g., (only) packets of DRBs arrive to the buffer of the UE side and the arrived packets are not associated with the SRB1 and SRB2).

In some implementations, the UE may select the operating UL carrier (only) based on the SDT RB(s), which implies the UE may initiate an SDT procedure (only) when the arrived packets are associated with the RBs that the serving RAN enables for SDT. In other implementations, the UE may not consider the arrived packets being associated with the non-SDT RBs (e.g., disabled by the serving RAN or are not allowed for SDT). For packet arrivals of the non-SDT bearers, the UE may initiate a conventional RRC resume procedure to resume the suspended RRC connection for packet delivery. The serving RAN may configure the SDT bearers as part of the SDT configuration. In some implementations, the serving RAN may configure (or enable, disable) the above bearer-based UL carrier selection approach as part of the SDT configuration.

In some implementations, during an SDT procedure, the UE may resume the SDT RBs for packet exchange. In other implementations, the UE may not resume the non-SDT RBs during the SDT procedure.

Impact of Redirected Carrier (information)

The impact of redirected carrier (information) (e.g., an IE redirectedCarrierInfo) on SDT (procedure) may be as follows.

In some implementations, the UE may receive the IE redirectedCarrierInfo in (or via) an RRCRelease message. The IE redirectedCarrierInfo may instruct (or redirect) the UE to a target frequency carrier (e.g., either in DL or UL when the frame structure is implemented on FDD or TDD).

In some implementations, the IE redirectedCarrierInfo may be configured as part of the SDT configuration at the UE side. In some other implementations, the IE redirectedCarrierInfo may not be configured as part of the SDT configuration at the UE side. In some implementations, the UE may receive the SDT configuration in the RRCReconfiguration and/or RRCRelease message. Thus, part of the SDT configuration may be transmitted in the RRCReconfiguration message and another part of the SDT configuration may be transmitted in the RRCRelease message. In the present disclosure, some implementations (e.g., control mechanisms) may be applied for the issues when the UE receives the IE redirectedCarrierInfo.

In some implementations, the UE may stay in a first (component) carrier (e.g., DL frequency carrier) associated with (e.g., paired with) a second (component) carrier (e.g., UL frequency carrier). The first carrier and the second carrier may be the same frequency carrier, or one of them may (e.g., partially) overlap the other one (e.g., in the TDD structure). In an RRCRelease message, the UE may receive an IE redirectedCarrierInfo, which redirects the UE to move to a third (component) carrier (e.g., DL frequency carrier) associated with (e.g., paired with) a fourth (component) carrier (e.g., UL frequency carrier). The third carrier and the fourth carrier may be the same frequency carrier, or one of them may (e.g., partially) overlap the other one (e.g., in the TDD structure). The serving RAN may configure an SDT resource configuration associated with the second carrier and/or the fourth carrier in the RRCRelease message or in another RRCReconfiguration message transmitted to the UE prior to the RRCRelease message.

It should be noted that the UE may be configured with SDT resources on one or more UL (radio frequency) carriers. The SDT resources associated with a UL radio frequency carrier may be any combination of UL-CG configuration and/or RA resources.

### Impact on SDT (Procedure)

In some implementations, the serving cell may transmit the RRCRelease message (with the IE redirectedCarrierInfo) to stop (or end, suspend) an ongoing (or active) SDT procedure. After receiving the RRCRelease message (with the attached IE redirectedCarrierInfo), the UE may move to another (e.g., DL or UL) carrier, which is indicated by the IE redirectedCarrierInfo.

In some implementations, the serving cell may transmit the RRCRelease message (with the IE redirectedCarrierInfo) during an active SDT procedure. The UE may perform (or continue) the SDT procedure by (or after) moving to another frequency carrier indicated by the IE redirectedCarrierInfo. When the active SDT procedure is finished, the UE may stay on the redirected (DL or UL) carrier (e.g., the third carrier or the fourth carrier).

In some other implementations, the serving cell may instruct the UE to move to another frequency carrier (e.g., the third carrier or the fourth carrier) via another RRC message (e.g., RRCReconfiguration message). The serving cell may configure SDT radio resources (e.g., UL-CG or CG-PUSCH configuration and/or RA resource configuration (e.g., associated with the fourth carrier), where the UL-CG configuration and RA resource configuration may be associated with one or more cells operating on the third carrier or the fourth carrier) along with the redirect carrier instruction in the same RRCReconfiguration message. After receiving the RRC message, the UE may move to another frequency carrier for SDT (e.g., by using the UL-CG configuration or RA resource configuration in the same RRCReconfiguration message). The UE may keep the UL-CG configuration and/or RA resource configuration after the ongoing SDT procedure is finished (or ended, stopped, released).

### SDT Resource Configuration Release (or Suspension) Caused by an IE Redirected CarrierInfo

In some implementations, the UE may release the stored SDT configuration associated with the second carrier after receiving an IE redirectedCarrierInfo, which redirects the UE to move to a third carrier (e.g., for DL operation, and the UE may also move to a fourth carrier for UL operation).

In some other implementations, the UE may not release the stored SDT configuration associated with the second carrier after receiving an IE redirectedCarrierInfo, which redirects the UE to move to a third carrier (e.g., for DL operation, and the UE may also move to a fourth carrier for UL operation). In some implementations, the third carrier and the fourth carrier may be the same. In some other implementations, the third carrier and the fourth carrier may be different.

In some implementations, after receiving the IE redirectedCarrierInfo to redirect the UE to another (e.g., NR) frequency carrier, the UE may (only) release part of the stored SDT configuration. For example, the UE may release the stored UL-CG configurations for SDT. The UE may be able to implement SDT on the frequency carrier indicated by the IE redirectedCarrierInfo. In some implementations, the UE may keep the RA resource configuration associated with the redirected frequqnecy carrier (e.g., which may be part of the stored SDT configuration) for the following SDT procedure(s) on the indicated frequency carrier.

### SDT-TAT Timer Validity Check

For SDT (operation), the UE may (need to) maintain an SDT-TAT timer to indicate the validity of one or more UL-CG configurations. However, before receiving the RRCRelease message (with the IE redirectedCarrierInfo), the running SDT-TAT timer may (only) be associated with the UL-CG configuration of second carrier.

In some implementations, the UE may stop the running SDT-TAT (e.g., running upon the UE receiving the RRCRelease message with the IE redirectedCarrierInfo) after receiving the RRCRelease message with the IE redirectedCarrierInfo to redirect the UE to another (DL or UL) carrier. In some other implementations, the UE may not stop the running SDT-TAT if the UE stays in the same (DL or UL) frequency carrier after the UE receives RRCRelease message.

In some implementations, the UE may keep the SDT-TAT timer counting procedure after receiving the IE redirectedCarrierInfo to redirect the UE to another frequency carrier (e.g. third carrier or fourth carrier). It may represent that the UL timing assocaited with the second carrier may be still valid while/after the UE moves to the fourth carrier (e.g., which may be indicated by the IE redirectedCarrierInfo) for the following DL/UL packets exchange. In some implementations, the UE may (be able to) reset (or restart) the SDT-TAT timer after the UE impelments (DL or UL) packet exchange with the serving RAN on the redirected DL/UL carrier (e.g., third carrier or fourth carrier).

### Impact on an RRC State

In some implementations, the serving cell may stop the SDT operation by transmitting the IE redirectedCarrierInfo to the UE without configuring the SDT resource configuration to the UE.

In some implementations, the IE redirectedCarrierInfo may be transmitted via an RRCRelease message with the suspend configuration. After receiving the RRCRelease message, the UE may release (or suspend) the stored SDT (resource) configuration, move to the indicated operating (DL or UL) frequency carrier(s) and stay in the RRC inactive state.

In some implementations, the IE redirectedCarrierInfo may redirect the UE to move to an E-UTRA frequency and to move to an E-UTRA cell (determined) as the serving cell. After receving such IE redirectedCarrierInfo, the UE may release (or suspend) the stored SDT configuration and move to the (E-UTRA) RRC idle state.

In some other implementations, the IE redirectedCarrierInfo may be transmitted via an RRCRelease message without the suspend configuration. After receiving the RRCRelease message (without the suspend configuration), the UE may release the stored SDT resource configuration, move to the indicated operating (DL or UL) frequency carrier(s), and move to the (NR) RRC idle state.

### Service Continuity

In some implementations, the UE may receive the RRCRelease message with the IE redirectedCarrierInfo during an SDT procedure. In some implementations, the UE may continue the SDT procedure by switching to the carrier indicated by the IE redirectedCarrierInfo. In some implementations, the UE may access the SDT resources configured on the UL carrier (e.g., NUL or SUL) associated with the IE redirectedCarrierInfo (e.g., the UL carrier paired with the DL carrier associated with the IE redirectedCarrierInfo) in the same SDT procedure after carrier switching.

In some implementations, an active RA-SDT procedure (e.g., which may be triggered before receiving the IE redirectedCarrierInfo (or RRCRelease message)) may be continued after the UE implements carrier switching based on the received IE redirectedCarrierInfo. Then, the UE may continue on an SDT procedure by accessing the CG-SDT/RA-SDT reosurce on the UL operating carrier assocaited with the IE redirectedCarrierInfo. In some implementations, an active RA-SDT procedure may be interrupted after receiving the IE redirectedCarrierInfo. Then, the UE may reinitiate an SDT procedure after redirecting to another carrier.

In some implementations, an active CG-SDT procedure (e.g., which may be triggered before receiving the IE redirectedCarrierInfo (or RRCRelease message)) may be continued after the UE implements carrier switching based on the received IE redirectedCarrierInfo. Then, the UE may continue on an SDT procedure by accessing the CG-SDT/RA-SDT resources on the UL operating carrier assocaited with the IE redirectedCarrierInfo. In some implementations, an active CG-SDT procedure may be interrupted after receiving the IE redirectedCarrierInfo. Then, the UE may reinitiate an SDT procedure after redirecting to another carrier.

### Prioritization Rules Based on the RRCRelease Message

The implementations in the present disclosure may be applicable to other specific frequency prioritization information or frequency de-prioritization provided via the RRCRelease message.

In the present disclosure, implementations for SDT, when two UL carriers (e.g., NUL carrier and/or SUL carrier) are (configured to be) associated with a DL carrier for SDT are jointly considered, are disclosed. Implementations for SDT when the IE redirectedCarrierInfo is jointly considered for SDT are disclosed.

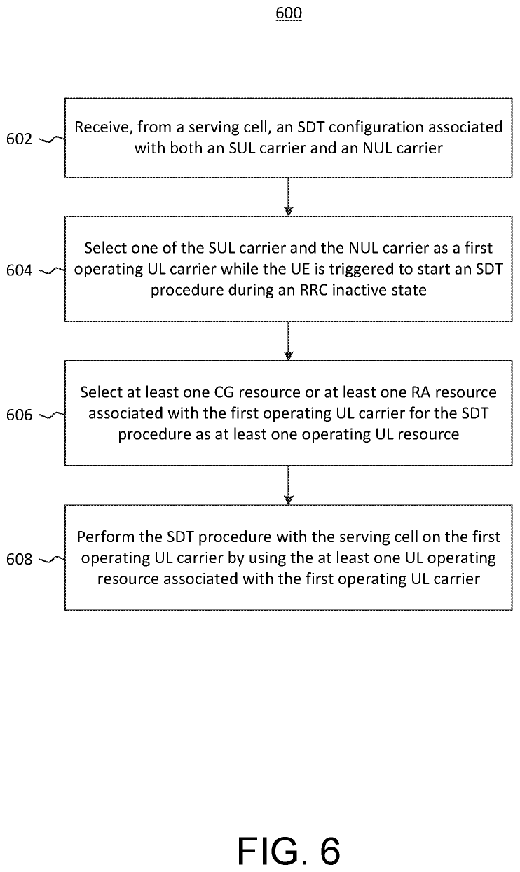

FIG. 6 is a flowchart illustrating a method 600 for handling SDT performed by a UE, according to an example implementation of the present disclosure. In action 602, the UE may receive, from a serving cell, an SDT configuration associated with both an SUL carrier and an NUL carrier. In action 604, the UE may select one of the SUL carrier and the NUL carrier as a first operating UL carrier when the UE is triggered to start an SDT procedure during an RRC inactive state (e.g., RRC_INACTIVE state). In action 606, the UE may select at least one CG resource or at least one RA resource associated with (e.g., configured on) the first operating UL carrier for the SDT procedure as at least one operating UL resource (e.g., during the RRC inactive state). That is, the UL operating carrier selection may be after the UL operating resource selection. In action 608, the UE may perform the SDT procedure with the serving cell on the first operating UL carrier by using the at least one UL operating resource associated with the first operating UL carrier (e.g., during the RRC inactive state).

In some implementations, the UE may disable switching from the first operating UL carrier to the other one of the SUL carrier and the NUL carrier during the SDT procedure. That is, the UE may (always) perform SDT on the first operating UL carrier during the SDT procedure (e.g., when the network does not instruct the UE to perform UL carrier switching) after selecting the first operating UL carrier for the SDT procedure.

In some implementations, the first operating UL carrier may be selected based on a DL RS measurement result of the UE and a threshold (e.g., sdt-RSRP-ThresholdSSB-SUL) configured by the SDT configuration for UL carrier selection during the SDT procedure. The DL RS measurement result may be in terms of RSRP associated the serving cell. The threshold may be configured with a DL-RSRP value different from another DL-RSRP threshold value (e.g., RSRP-ThresholdSSB-SUL) configured to the UE for UL carrier selection during an RRC resume procedure or an RRC setup procedure with the same serving cell.

In some implementations, the first operating UL carrier may be selected based on the following rules: selecting the SUL carrier as the first operating UL carrier in a case that the DL RS measurement result is less than the threshold; and selecting the NUL carrier as the first operating UL carrier in a case that the DL RS measurement result is not less than the threshold.

In some implementations, the UE may receive, from the serving cell during the SDT procedure, first DCI including a first (NUL/SUL) indication. The first indication may indicate UL carrier switching from the first operating UL carrier to a second operating UL carrier, the second operating UL carrier being the other one of the SUL carrier and the NUL carrier. Then, the UE may perform the SDT procedure with the serving cell by transmitting at least one first TB on a UL physical resource on the second operating UL carrier indicated by the first DCI.

In some implementations, the UE may switch from the second operating UL carrier back to the first operating UL carrier automatically after transmitting the at least one first TB on the UL physical resource indicated by the first DCI. Then, the UE may perform the SDT procedure with the serving cell on the first operating UL carrier. That is, the UE may perform a single SDT on the second operating UL carrier and (determine by the UE itself to) switch back after the dynamic grant (or the single SDT). Then, the UE may perform subsequent SDT on the first operating UL carrier.

In some implementations, the UE may receive, from the serving cell during the SDT procedure, second DCI including a second indication after transmitting the at least one first TB on the UL physical resource indicated by the first DCI. The second indication may indicate UL carrier switching from the second operating UL carrier to the first operating UL carrier. Then, the UE may perform the SDT procedure with the serving cell by transmitting at least one second TB on a UL physical resource on the first operating UL carrier indicated by the second DCI. That is, the UE may (always) perform at least an SDT on the second operating UL carrier after receiving the first indication. The UE may switch back to the first operating UL carrier in response to (or by obeying) the determination of the network (e.g., second indication).

In some implementations, the at least one CG resource on the first operating UL carrier for the SDT procedure may be selected as the at least one operating UL resource in a case that the at least one CG resource is available for the SDT procedure when a TA timer of the at least one CG resource is still running (e.g., not expired) when selecting the at least one operating UL resource. That is, a CG resource with a running TA timer is available for the SDT procedure and may be selected as an operating UL resource for the SDT procedure.

In some implementations, the UE may release all of configured CG resources on the NUL and SUL carrier in a case that a TA timer of the at least one CG resource expires.

In some implementations, the at least one RA resource on the first operating UL carrier for the SDT procedure may be selected as the at least one UL operating resource in a case that (or unless) there is no available CG resource associated with the first operating UL carrier. That is, if no CG resource is configured on the operating UL carrier, an RA resource on the operating UL carrier may be selected as an UL operating resource. If one (or more) CG resource configured on the operating UL carrier is not available for the SDT procedure (e.g., a TA timer of the one (or more) CG resource is expired), an RA resource on the operating UL carrier may be selected as an UL operating resource.

In some implementations, the SDT configuration may be received during an RRC connected state (e.g., RRC_CONNECTED state).

It should be noted that the order in which the process is described is not intended to be construed as a limitation, and any number of the described actions may be combined in any order to implement the method or an alternate method. Moreover, one or more of the actions illustrated in FIGS. 3 through 6 may be omitted in some implementations.

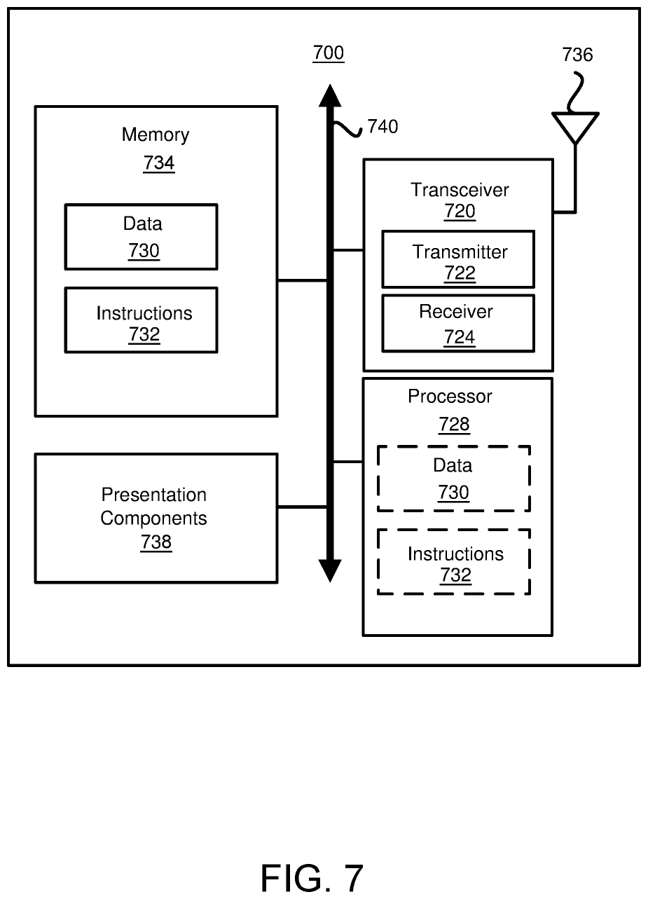

FIG. 7 is a block diagram illustrating a node 700 for wireless communication, according to an example implementation of the present disclosure. As illustrated in FIG. 7, a node 700 may include a transceiver 720, a processor 728, a memory 734, one or more presentation components 738, and at least one antenna 736. The node 700 may also include a RF spectrum band module, a BS communications module, a network communications module, and a system communications management module, Input/Output (I/O) ports, I/O components, and a power supply (not illustrated in FIG. 7).

Each of the components may directly or indirectly communicate with each other over one or more buses 740. The node 700 may be a UE or a BS that performs various functions disclosed with reference to FIGS. 1 through 6.

The transceiver 720 has a transmitter 722 (e.g., transmitting/transmission circuitry) and a receiver 724 (e.g., receiving/reception circuitry) and may be configured to transmit and/or receive time and/or frequency resource partitioning information. The transceiver 720 may be configured to transmit in different types of subframes and slots including but not limited to usable, non-usable and flexibly usable subframes and slot formats. The transceiver 720 may be configured to receive data and control channels.

The node 700 may include a variety of computer-readable media. Computer-readable media may be any available media that may be accessed by the node 700 and include both volatile and non-volatile media, removable and non-removable media.

The computer-readable media may include computer storage media and communication media. Computer storage media include both volatile and non-volatile, removable and non-removable media implemented in any method or technology for storage of information such as computer-readable instructions, data structures, program modules or data.

Computer storage media include RAM, ROM, EEPROM, flash memory or other memory technology, CD-ROM, Digital Versatile Disks (DVD) or other optical disk storage, magnetic cassettes, magnetic tape, magnetic disk storage or other magnetic storage devices. Computer storage media do not include a propagated data signal. Communication media typically embody computer-readable instructions, data structures, program modules or other data in a modulated data signal such as a carrier wave or other transport mechanism and include any information delivery media.

The term “modulated data signal” means a signal that has one or more of its characteristics set or changed in such a manner as to encode information in the signal. Communication media include wired media such as a wired network or direct-wired connection, and wireless media such as acoustic, RF, infrared and other wireless media. Combinations of any of the previously listed components should also be included within the scope of computer-readable media.

The memory 734 may include computer-storage media in the form of volatile and/or non-volatile memory. The memory 734 may be removable, non-removable, or a combination thereof. Example memory includes solid-state memory, hard drives, optical-disc drives, etc. As illustrated in FIG. 7, the memory 734 may store computer-readable, computer-executable instructions 732 (e.g., software codes) that are configured to cause the processor 728 to perform various disclosed functions, for example, with reference to FIGS. 1 through 6. Alternatively, the instructions 732 may not be directly executable by the processor 728 but be configured to cause the node 700 (e.g., when compiled and executed) to perform various disclosed functions.

The processor 728 (e.g., having processing circuitry) may include an intelligent hardware device, e.g., a Central Processing Unit (CPU), a microcontroller, an ASIC, etc. The processor 728 may include memory. The processor 728 may process data 730 and the instructions 732 received from the memory 734, and information transmitted and received via the transceiver 720, the base band communications module, and/or the network communications module. The processor 728 may also process information to be sent to the transceiver 720 for transmission via the antenna 736 to the network communications module for transmission to a CN.

One or more presentation components 738 present data indications to a person or another device. Examples of presentation components 738 include a display device, a speaker, a printing component, and a vibrating component, etc.

In view of the present disclosure, it is obvious that various techniques may be used for implementing the concepts in the present disclosure without departing from the scope of those concepts. Moreover, while the concepts have been disclosed with specific reference to certain implementations, a person of ordinary skill in the art will recognize that changes may be made in form and detail without departing from the scope of those concepts. As such, the disclosed implementations are to be considered in all respects as illustrative and not restrictive. It should also be understood that the present disclosure is not limited to the particular implementations disclosed and many rearrangements, modifications, and substitutions are possible without departing from the scope of the present disclosure.

1. A method for handling small data transmission (SDT) performed by a user equipment (UE), the method comprising:
receiving, from a serving cell, an SDT configuration associated with both a supplementary uplink (SUL) carrier and a normal uplink (NUL) carrier;
selecting one of the SUL carrier and the NUL carrier as a first operating uplink (UL) carrier when the UE is triggered to start an SDT procedure and while the UE is in a radio resource control (RRC) inactive state;
selecting at least one configured grant (CG) resource or at least one random access (RA) resource associated with the first operating UL carrier for the SDT procedure as at least one operating UL resource;
performing the SDT procedure with the serving cell on the first operating UL carrier by using the at least one UL operating resource associated with the first operating UL carrier; and
disabling a switching from the first operating UL carrier to the other one of the SUL carrier and the NUL carrier during the SDT procedure.

2. (canceled)

3. The method of claim 1, wherein:
the first operating UL carrier is selected based on a downlink (DL) reference signal (RS) measurement result of the UE and a threshold configured by the SDT configuration for UL carrier selection during the SDT procedure,
the DL RS measurement result is based on a reference signal received power (RSRP) associated with the serving cell, and
the threshold is configured with a DL-RSRP value different from another DL-RSRP threshold value configured to the UE for UL carrier selection during an RRC resume procedure or an RRC setup procedure with the same serving cell.

4. The method of claim 3, wherein selecting the first operating UL carrier comprises:
selecting the SUL carrier as the first operating UL carrier in a case that the DL RS measurement result is less than the threshold, and
selecting the NUL carrier as the first operating UL carrier in a case that the DL RS measurement result greater than or equal to the threshold.

5. The method of claim 1, further comprising:
receiving, from the serving cell during the SDT procedure, first downlink control information (DCI) including a first indication, the first indication indicating an UL carrier switching from the first operating UL carrier to a second operating UL carrier, the second operating UL carrier being the other one of the SUL carrier and the NUL carrier; and
performing the SDT procedure with the serving cell by transmitting at least one first transport block (TB) on a UL physical resource on the second operating UL carrier indicated by the first DCI.

6. The method of claim 5, further comprising:
switching from the second operating UL carrier back to the first operating UL carrier automatically after transmitting the at least one first TB on the UL physical resource indicated by the first DCI; and
performing the SDT procedure with the serving cell on the first operating UL carrier.

7. The method of claim 5, further comprising:
receiving, from the serving cell during the SDT procedure, second DCI including a second indication after transmitting the at least one first TB on the UL physical resource indicated by the first DCI, the second indication indicating another UL carrier switching from the second operating UL carrier to the first operating UL carrier; and
performing the SDT procedure with the serving cell by transmitting at least one second TB on a UL physical resource on the first operating UL carrier indicated by the second DCI.

8. The method of claim 1, wherein the at least one CG resource on the first operating UL carrier for the SDT procedure is selected as the at least one operating UL resource in a case that the at least one CG resource is available for the SDT procedure when a time alignment (TA) timer of the at least one CG resource is still running when selecting the at least one operating UL resource.

9. The method of claim 1, further comprising:
releasing all of configured CG resources on the NUL carrier and the SUL carrier in a case that a time alignment (TA) timer of the at least one CG resource expires.

10. The method of claim 1, wherein the at least one RA resource on the first operating UL carrier for the SDT procedure is selected as the at least one UL operating resource in a case that there is no available CG resource associated with the first operating UL carrier.

11. A user equipment (UE) for handling small data transmission (SDT), comprising:
one or more non-transitory computer-readable media storing one or more computer-executable instructions; and
at least one processor coupled to the one or more non-transitory computer-readable media and configured to execute the one or more computer-executable instructions to cause the UE to:
receive, from a serving cell, an SDT configuration associated with both a supplementary uplink (SUL) carrier and a normal uplink (NUL) carrier;
select one of the SUL carrier and the NUL carrier as a first operating uplink (UL) carrier when the UE is triggered to start an SDT procedure and while the UE is in a radio resource control (RRC) inactive state;
select at least one configured grant (CG) resource or at least one random access (RA) resource associated with the first operating UL carrier for the SDT procedure as at least one operating UL resource;
perform the SDT procedure with the serving cell on the first operating UL carrier by using the at least one UL operating resource associated with the first operating UL carrier; and
disable a switching from the first operating UL carrier to the other one of the SUL carrier and the NUL carrier during the SDT procedure.

12. The UE of claim 11, wherein:
the first operating UL carrier is selected based on a downlink (DL) reference signal (RS) measurement result of the UE and a threshold configured by the SDT configuration for UL carrier selection during the SDT procedure,
the DL RS measurement result is based on a reference signal received power (RSRP) associated with the serving cell, and
the threshold is configured with a DL-RSRP value different from another DL-RSRP threshold value configured to the UE for UL carrier selection during an RRC resume procedure or an RRC setup procedure with the same serving cell.

13. The UE of claim 12, wherein selecting the first operating UL carrier comprises:
selecting the SUL carrier as the first operating UL carrier in a case that the DL RS measurement result is less than the threshold, and
selecting the NUL carrier as the first operating UL carrier in a case that the DL RS measurement result greater than or equal to the threshold.

14. The UE of claim 11, wherein the at least one processor is further configured to execute the one or more computer-executable instructions to cause the UE to:
receive, from the serving cell during the SDT procedure, first downlink control information (DCI) including a first indication, the first indication indicating an UL carrier switching from the first operating UL carrier to a second operating UL carrier, the second operating UL carrier being the other one of the SUL carrier and the NUL carrier; and
perform the SDT procedure with the serving cell by transmitting at least one first transport block (TB) on a UL physical resource on the second operating UL carrier indicated by the first DCI.

15. The UE of claim 14, wherein the at least one processor is further configured to execute the one or more computer-executable instructions to cause the UE to:
switch from the second operating UL carrier back to the first operating UL carrier automatically after transmitting the at least one first TB on the UL physical resource indicated by the first DCI; and
perform the SDT procedure with the serving cell on the first operating UL carrier.

16. The UE of claim 14, wherein the at least one processor is further configured to execute the one or more computer-executable instructions to cause the UE to:
receive, from the serving cell during the SDT procedure, second DCI including a second indication after transmitting the at least one first TB on the UL physical resource indicated by the first DCI, the second indication indicating another UL carrier switching from the second operating UL carrier to the first operating UL carrier; and
perform the SDT procedure with the serving cell by transmitting at least one second TB on a UL physical resource on the first operating UL carrier indicated by the second DCI.

17. The UE of claim 11, wherein the at least one CG resource on the first operating UL carrier for the SDT procedure is selected as the at least one operating UL resource in a case that the at least one CG resource is available for the SDT procedure when a time alignment (TA) timer of the at least one CG resource is still running when selecting the at least one operating UL resource.

18. The UE of claim 11, wherein the at least one processor is further configured to execute the one or more computer-executable instructions to cause the UE to:
release all of configured CG resources on the NUL carrier and the SUL carrier in a case that a time alignment (TA) timer of the at least one CG resource expires.

19. The UE of claim 11, wherein the at least one RA resource on the first operating UL carrier for the SDT procedure is selected as the at least one UL operating resource in a case that there is no available CG resource associated with the first operating UL carrier.
